(19) United States
(12) Patent Application Publication
(10) Pub. No.: US 2025/0189745 A1
(43) Pub. Date: Jun. 12, 2025

(54) NETWORK ACCESS POINT (NAP) ENCLOSURES

(71) Applicant: PPC BROADBAND, INC., East Syracuse, NY (US)

(72) Inventors: Nicholas B. LARSSON, Blomkest, MN (US); William L. CRAWFORD, Syracuse, NY (US); Ruta MANGLE, East Syracuse, NY (US); Cameron ADAMS, Camillus, NY (US)

(73) Assignee: PPC BROADBAND, INC., East Syracuse, NY (US)

(21) Appl. No.: 19/056,499

(22) Filed: Feb. 18, 2025

Related U.S. Application Data
(63) Continuation of application No. 17/749,975, filed on May 20, 2022, now Pat. No. 12,228,781.
(60) Provisional application No. 63/295,341, filed on Dec. 30, 2021.
(60) Provisional application No. 63/191,258, filed on May 20, 2021.

(51) Int. Cl. G02B 6/44

(52) U.S. Cl. CPC G02B 6/4452; G02B 6/4442

(57) ABSTRACT

A network access point enclosure is configured to house a splice tray that is configured to pivot to provide increased access to opposite sides of the splice tray during assembly. The enclosure includes a base, a cover configured to be sealingly coupled with the base to form a housing, and a splice tray configured to be pivotally coupled with the base. The splice tray is configured to be pivoted between a first orientation relative to the base and a second orientation relative to the base. The splice tray is configured to form a larger angle relative to the base in the first orientation than in the second orientation, and the splice tray is configured to provide increased access to a front side of the splice tray and a rear side of the splice tray in the first orientation than in the second orientation.

### CROSS REFERENCE TO RELATED APPLICATIONS

This application is a continuation of U.S. Nonprovisional application Ser. No. 17/749,975, filed May 20, 2022, pending, claims the benefit of U.S. Provisional Application No. 63/295,341, filed Dec. 30, 2021, and U.S. Provisional Application No. 63/191,258, filed May 20, 2021, the disclosures of which are hereby incorporated by reference herein in their entirety.

### TECHNICAL FIELD

The present disclosure relates generally to telecommunications connection devices and, more particularly, network access point (NAP) enclosures for extending fiber optic service to end users.

### BACKGROUND

Optical fiber systems are increasingly used in a variety of communications applications, including voice, video, and data transmissions, because they offer a high bandwidth for signal transmission, low noise operation, and inherent immunity to electromagnetic interference. Such systems typically require connections of optical fibers at various points in the network. For example, connection points are commonly needed to (i) connect individual optical fiber cable lengths to create a longer continuous optical fiber, (ii) create branching points that reroute fibers in the same cable in different directions as needed to provide fibers at desired locations, and (iii) connect active and passive components of the system.

One such connection point is a network access point (NAP). Conventional network access points include a rigid enclosure and have a predetermined fiber drop output angle. Such conventional network access points can cause difficulty for technicians with installation on a pole or in a pedestal/vault. Also, some conventional network access point enclosures utilize an epoxy potting assembly which is often a difficult process and make the enclosure a one-time use item.

It may be desirable to have network access point enclosures that are configured to receive a multi fiber optic cable input, for example, a cable with four to twelve fibers, and provide numerous outputs of flexible drop cables. It may be desirable to provide network access point enclosures that provide fiber management, splicing, breakout, and/or pass through capabilities in a compact assembly

It may be desirable to have network access point enclosures that are configured to receive a distribution fiber cable (i.e., a multifiber cable) input, for example, a cable with four to twelve fibers, and provide a plurality of outputs of flexible fiber optic cables that extend from the enclosure and are terminated with an adapter configured to be coupled with a fiber optic connector of a drop cable. It may be desirable to provide network access point enclosures that provide environmental seals at the ports where the flexible fiber optic output cables exit the enclosure.

It may be desirable to provide a network access point enclosure including a splice tray that is configured to be pivotal between a first orientation relative to the base and a second orientation relative to the base, wherein the splice tray is configured to form a larger angle relative to the base in the first orientation than in the second orientation such that the splice tray is configured to provide increased access to a front side of the splice tray and a rear side of the splice tray in the first orientation relative to the second orientation. It may also be desirable to provide a splice tray that is configured to prevent a cover from being coupled with a base in the first orientation and to permit the cover to be sealingly coupled with the base in the second orientation.

### SUMMARY

According to various exemplary aspects of the present disclosure, a network access point enclosure is configured to sealingly house a splice tray that is configured to pivot to provide increased access to opposite sides of the splice tray during assembly. The network access point enclosure includes a base, a cover configured to be sealingly coupled with the base to form a housing, a retainer configured to be coupled with the base, and a splice tray configured to be pivotally coupled with the retainer. The splice tray is configured to be pivoted between a first orientation relative to the base and a second orientation relative to the base, and the splice tray is configured to form a larger angle relative to the base in the first orientation than in the second orientation. The retainer includes a first engagement structure configured to receive a first portion of a support arm that extends from the splice tray to hold the splice tray in the first orientation and a second engagement structure configured to receive a second portion of a support arm to hold the splice tray in the second orientation. The base portion includes a plurality of ports configured to receive fiber optic cables. A coupling assembly is configured to couple each fiber optic cable with one of the plurality of ports such that fiber optic cable is rotatingly and slidingly fixed relative to the one port. The retainer is configured to be removed from the base when the cover is not attached to the base. The splice tray is configured to provide increased access to a front side of the splice tray and a rear side of the splice tray in the first orientation relative to the second orientation. The splice tray is configured to prevent the cover from being coupled with the base in the first orientation and to permit the cover to be sealingly coupled with the base in the second orientation.

In some embodiments, the cover is configured to be ultrasonically welded to the base.

According to various embodiments, a coupling assembly is configured to couple a fiber optic cable with one of the ports of the base, and the coupling assembly includes an adapter having a threaded interface port configured to receive a threaded coupler that is attached to and configured to rotate relative to the fiber optic cable.

In various embodiments, the fiber optic cable is configured to be sealingly coupled with the port with heat shrink.

According to some embodiments, at least one of the plurality of ports is configured to sealingly receive a drop cable.

In accordance with various exemplary aspects of the present disclosure, a network access point enclosure is configured to house a splice tray that is configured to pivot to provide increased access to opposite sides of the splice tray during assembly. The network access point enclosure includes a base, a cover configured to be sealingly coupled with the base to form a housing, a retainer configured to be coupled with the base, and a splice tray configured to be pivotally coupled with the retainer. The splice tray is configured to be pivoted between a first orientation relative to the base and a second orientation relative to the base and to form a larger angle relative to the base in the first orientation than in the second orientation. The base portion includes a plurality of ports configured to receive fiber optic cables, and each port is configured to couple with a fiber optic cable such that fiber optic cable is rotatingly and slidingly fixed relative to the one port. The splice tray is configured to provide increased access to a front side of the splice tray and a rear side of the splice tray in the first orientation than in the second orientation. The splice tray is configured to prevent the cover from being coupled with the base in the first orientation and to permit the cover to be sealingly coupled with the base in the second orientation.

In some embodiments, the retainer includes a first engagement structure configured to receive a first portion of a support arm that extends from the splice tray to hold the splice tray in the first orientation and a second engagement structure configured to receive a second portion of a support arm to hold the splice tray in the second orientation.

According to some embodiments, the retainer is configured to be removed from the base when the cover is not attached to the base.

In various embodiments, the cover is configured to be sealingly coupled with the base. For example, in some embodiments, the cover may be ultrasonically welded to the base.

According to various embodiments, the network access point enclosure further includes a coupling assembly configured to couple a fiber optic cable with one of the ports of the base, and the coupling assembly includes an adapter having a threaded interface port configured to receive a threaded coupler that is attached to and configured to rotate relative to the fiber optic cable.

In some embodiments, the fiber optic cable is configured to be sealingly coupled with the port with heat shrink.

In various embodiments, at least one of the plurality of ports is configured to sealingly receive a drop cable.

According to various aspects of the present disclosure, a network access point enclosure is configured to sealingly house a splice tray that is configured to pivot to provide increased access to opposite sides of the splice tray during assembly. The enclosure includes a base, a cover configured to be sealingly coupled with the base to form a housing, and a splice tray configured to be pivotally coupled with the base. The splice tray is configured to be pivoted between a first orientation relative to the base and a second orientation relative to the base. The splice tray is configured to form a larger angle relative to the base in the first orientation than in the second orientation, and the splice tray is configured to provide increased access to a front side of the splice tray and a rear side of the splice tray in the first orientation than in the second orientation.

In some embodiments, the splice tray is configured to prevent the cover from being coupled with the base in the first orientation and to permit the cover to be sealingly coupled with the base in the second orientation.

According to some embodiments, the network access point further includes a retainer configured to be coupled with the base. In some aspects, the retainer includes a first engagement structure configured to receive a first portion of a support arm that extends from the splice tray to hold the splice tray in the first orientation and a second engagement structure configured to receive a second portion of a support arm to hold the splice tray in the second orientation. According to various aspects, the retainer includes a third engagement structure configured to receive a portion of a second support arm that extends from the splice tray to hold the splice tray in the second orientation.

In various embodiments, the retainer is configured to be removed from the base when the cover is not attached to the base.

In some embodiments, the cover is configured to be sealingly coupled with the base. For example, in some embodiments, the cover may be ultrasonically welded to the base.

According to various aspects, the base portion includes a plurality of ports configured to receive fiber optic cables. In some aspects, each port is configured to couple with a fiber optic cable such that the fiber optic cable is rotatingly and slidingly fixed relative to the one port. According to various aspects, a coupling assembly is configured to couple a fiber optic cable with one of the ports of the base, and the coupling assembly includes an adapter having a threaded interface port configured to receive a threaded coupler that is attached to and configured to rotate relative to the fiber optic cable. According to some aspects, the fiber optic cable is configured to be sealingly coupled with the port with heat shrink.

In various aspects, at least one of the plurality of ports is configured to sealingly receive a drop cable.

### BRIEF DESCRIPTION OF THE DRAWINGS

FIG. 1 is a first perspective view of an exemplary network access point (NAP) enclosure in accordance with various aspects of the disclosure.

FIG. 2A is a second perspective view of the NAP enclosure of FIG. 1.

FIG. 2B is a perspective view of the cover of the NAP enclosure of FIG. 2.

FIG. 3 is a perspective view of the base of the NAP enclosure of FIG. 1.

FIG. 4A is a top view of the base of the NAP enclosure of FIG. 1.

FIG. 4B is a cross-sectional view of the base of the NAP enclosure of FIG. 1.

FIGS. 5A and 5B are exploded and perspective views, respectively, of a fiber optic cable coupled with the base of the NAP enclosure of FIG. 1.

FIGS. 6A and 6B are cross-sectional view of the fiber optic cable coupled with the base of FIGS. 5A and 5B.

FIG. 7 is a perspective view of an adapter of the coupling assembly for the fiber optic cable coupled with the base of FIGS. 5A and 5B.

FIGS. 8A-8C are exploded and perspective views, respectively, of another fiber optic cable coupled with the base of the NAP enclosure of FIG. 1.

FIG. 8D is a cross-sectional view of the fiber optic cable coupled with the base of the NAP enclosure of FIGS. 8A-8C.

FIG. 9 is a perspective view of crimp ring for the fiber optic cable coupled with the base of the NAP enclosure of FIGS. 8A-8C.

FIGS. 10A-10C are exploded and perspective views, respectively, of a retainer coupled with the base of the NAP enclosure of FIG. 1.

FIG. 11 is a perspective view of a splice tray for use with the NAP enclosure of FIG. 1.

FIGS. 12A-12I are front and perspective view of various configurations of the splice tray of FIG. 11 coupled with the retainer and base of FIGS. 10A-10C.

FIG. 13 is an exploded perspective view of the enclosure of an exemplary network access point in accordance with various aspects of the disclosure.

FIG. 14 is a perspective view of an exemplary fiber management and distribution tray of the network access point of FIG. 13 in an unfolded configuration.

FIG. 15 is a perspective view of an exemplary fiber management and distribution tray of the network access point of FIG. 13 in a folded configuration.

FIG. 16 is a perspective view of an exemplary base of the enclosure of FIG. 13.

FIG. 17 is a side cross-sectional view of the base of the enclosure and the base portion of the fiber management and distribution tray of FIG. 13.

FIG. 18 is a front perspective view of the base of the enclosure of FIG. 13 with an alternative exemplary fiber management and distribution tray in a folded configuration.

FIG. 19 is a rear perspective view of the base and exemplary fiber management and distribution tray in a folded configuration of FIG. 18.

FIG. 20 is a perspective view of another exemplary fiber management and distribution tray in an unfolded configuration.

FIG. 21 is a perspective view of the fiber management and distribution tray of FIG. 20 in a first folded configuration.

FIG. 22 is a perspective view of the fiber management and distribution tray of FIG. 20 in a second folded configuration.

FIG. 23 is a perspective view of alternative base of the enclosure and the output fiber optic cables of FIG. 13.

FIG. 24 is a cross-sectional view of an exemplary coupling assembly for use with the base of FIG. 23.

FIG. 25 is an exploded perspective view of the plug of the coupling assembly of FIG. 24.

FIG. 26 is a cross-sectional view of the exemplary coupling assembly of FIG. 24 coupled with a cable.

FIG. 27 is a perspective view of another exemplary coupling assembly with the base of FIG. 23.

FIG. 28 is a side cross-sectional view of the coupling assembly of FIG. 6 with the base of FIG. 23.

FIG. 29 is a top view of the plug of the coupling assembly of FIG. 27.

FIG. 30 is a side cross-sectional view of another exemplary coupling assembly with the base of FIG. 23 in a first configuration.

FIG. 31 is a side cross-sectional view of the coupling assembly of FIG. 30 with the base of FIG. 23 in a second configuration.

FIG. 32 is a perspective view of the grommet of the coupling assembly of FIG. 30.

FIG. 33 is a side cross-sectional view of another exemplary coupling assembly with the base of FIG. 23 in a first configuration.

FIG. 34 is a side cross-sectional view of another exemplary coupling assembly with the base of FIG. 23 in a first configuration.

FIG. 35 is a side cross-sectional view of another exemplary coupling assembly with the base of FIG. 23 in a first configuration.

### DETAILED DESCRIPTION OF EMBODIMENTS

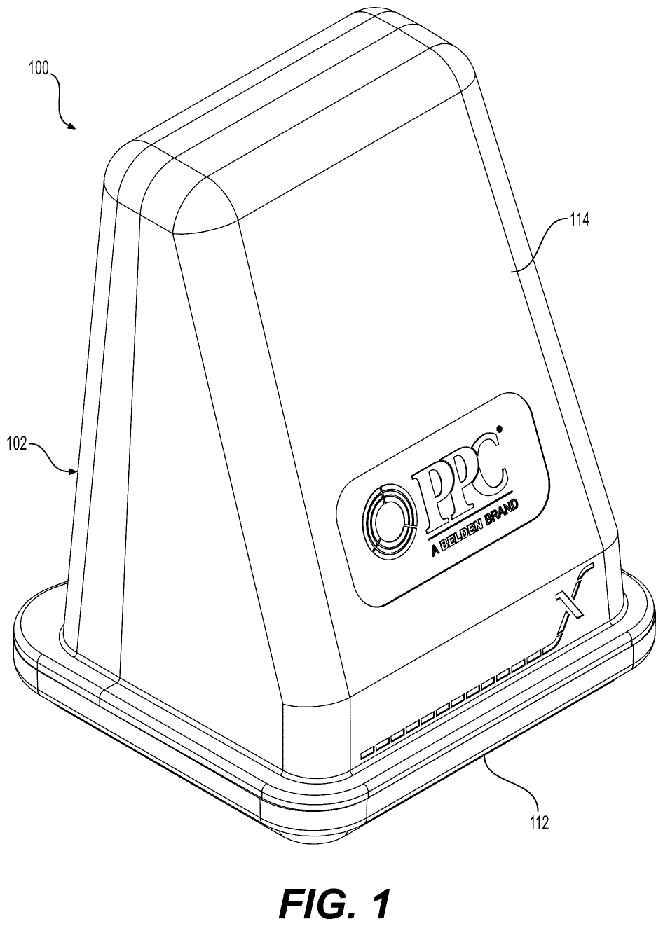

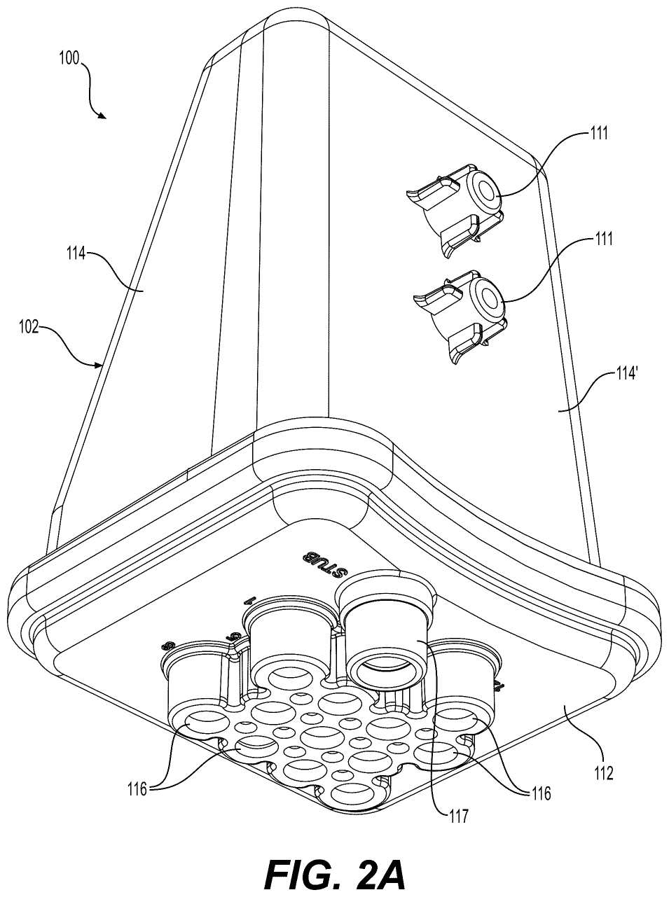

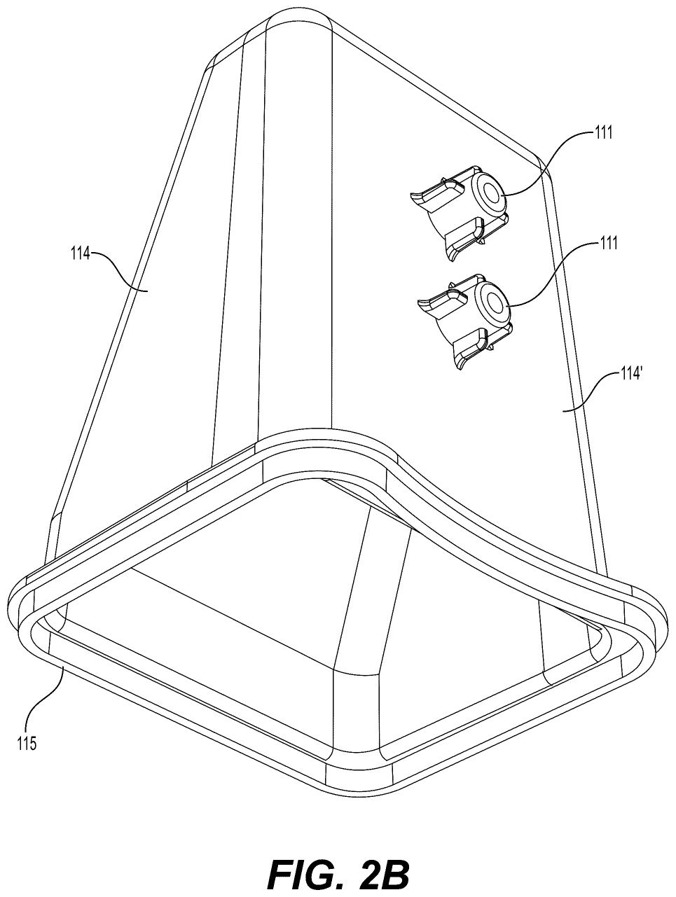

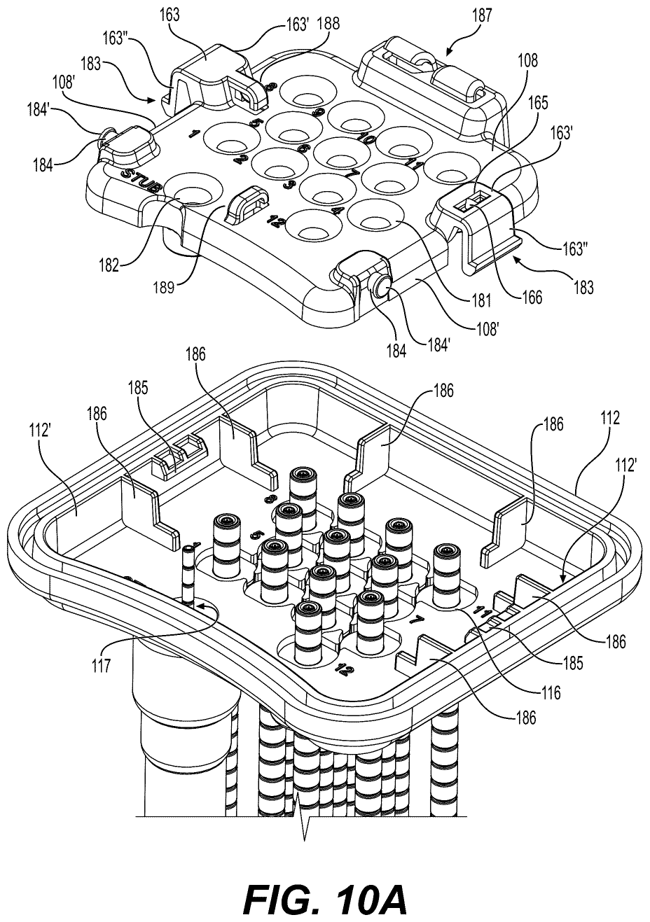

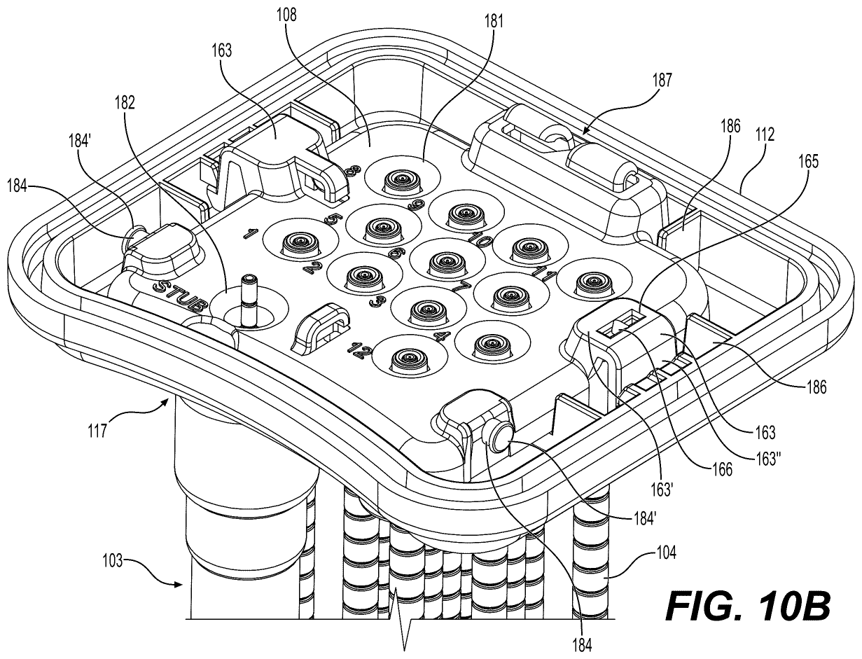

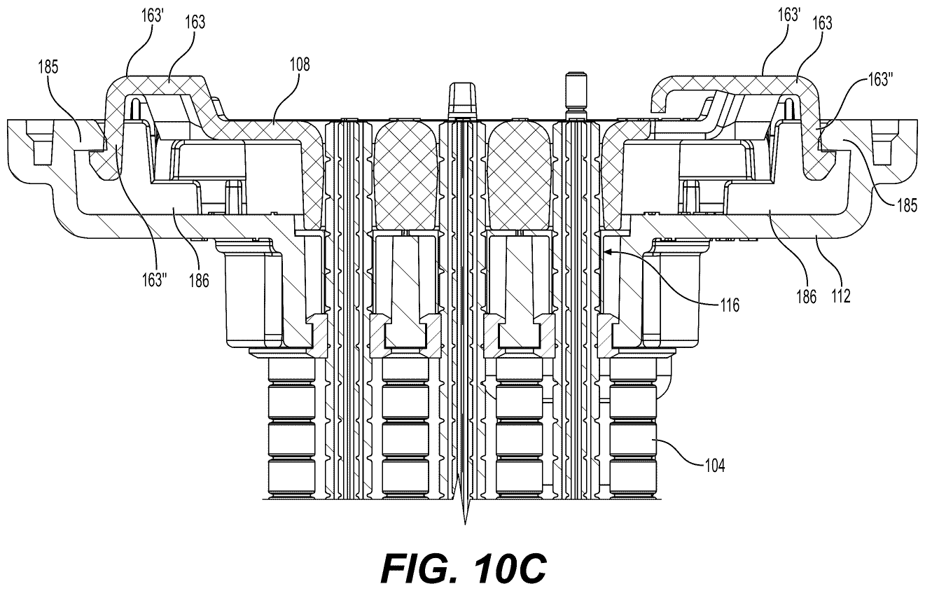

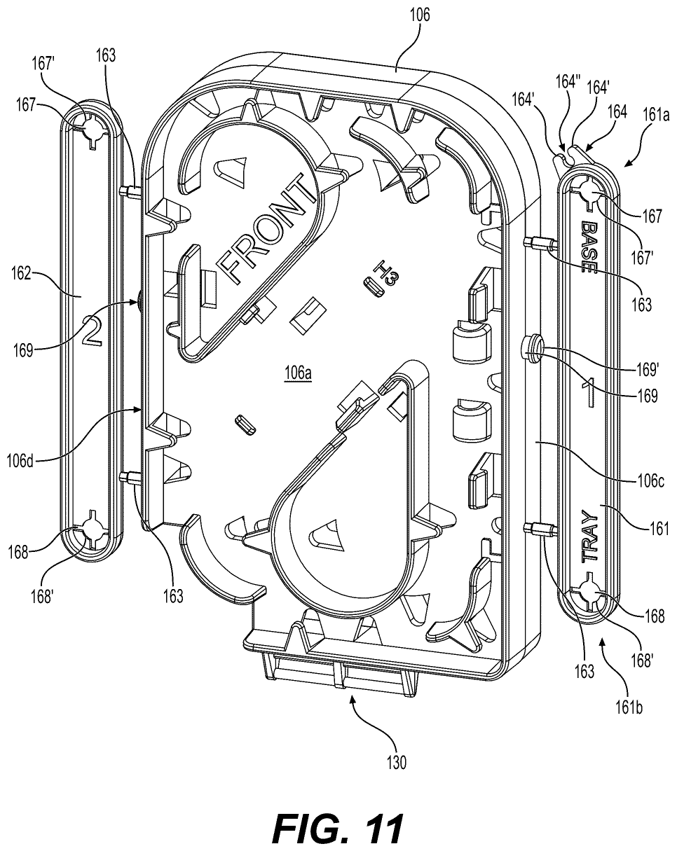

FIGS. 1-2A illustrate an exemplary network access point (NAP) enclosure 100 according to various aspects of the disclosure. The network access point enclosure 100 includes a housing 102, a splice tray 106 (FIG. 11), and a retainer 108 (FIG. 10A). The housing 102 includes a base 112 and a cover 114 configured to enclose the splice tray 106 and the retainer 108. The base 112 includes a peripheral groove 113 configured to receive a peripheral flange 115 of the cover 114. The base 112 and the cover 114 are configured to be coupled together to provide a housing. In some aspects, the base 112 and the cover 114 are configured to be sealingly coupled together to provide a weatherproof housing 102. For example, in some aspects, the base 112 and the cover 114 may be ultrasonically welded together at the flange 115 and groove 113 to provide an environmental seal, thereby providing a weatherproof housing that protects the interior of the housing 102 from external environment. Of course, the base 112 and the cover 114 may be sealingly coupled together by other means in order to provide a weatherproof housing 102. As shown in FIG. 2, a rear exterior wall 114′ of the cover 114 includes projections 111 configured to facilitate mounting of the NAP enclosure 100 to a wall mount, a pole mount, a strand mount, etc. (not shown).

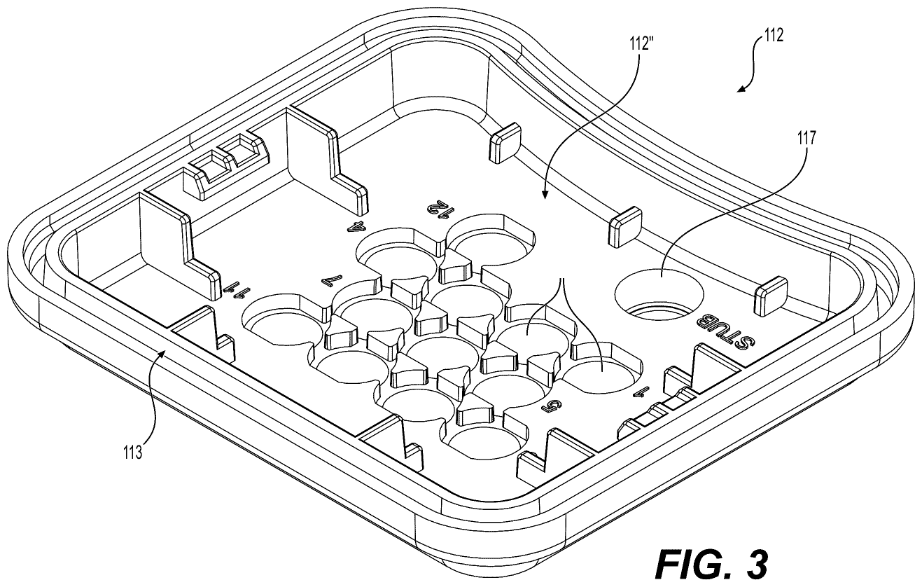

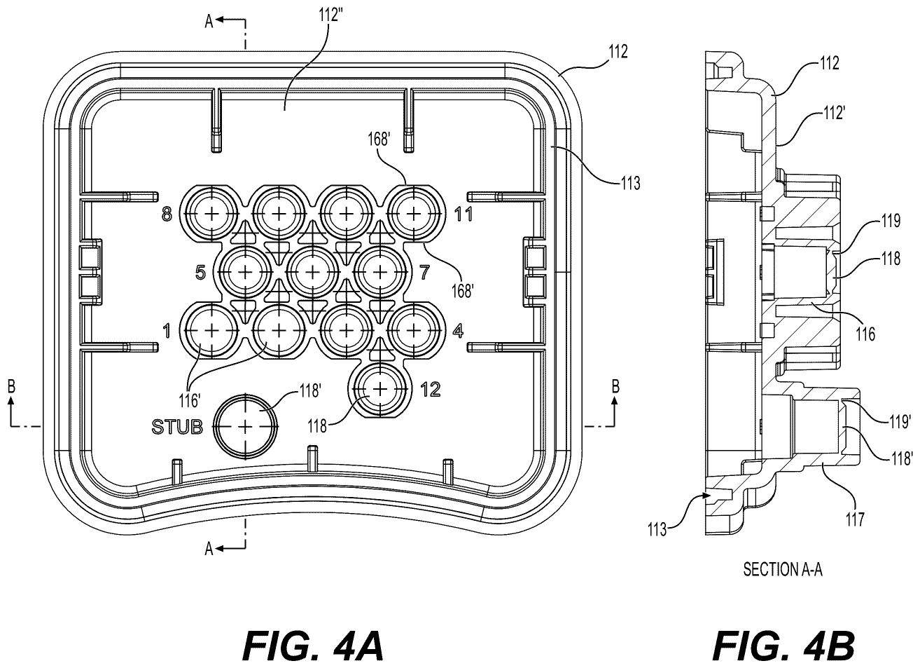

As illustrated in FIGS. 2A-4B, the base 112 may include a plurality of ports 116 configured to receive fiber optic cables 104 (e.g., drop cables) and one port 117 configured to receive a fiber optic cable 103 (e.g., an aerial drop cable or a duct). The ports 116 may extend from a bottom surface 112′ of the base 112, as shown in FIG. 2. In the illustrated embodiment, the base 112 includes twelve ports 116 configured to receive drop cables. Two ports 116′ of the plurality of ports 116 may be manufactured as open ports, while the remaining ten ports 116 may be manufactured as a closed port including a punchout portion 118 that has a weakened portion 119 about its periphery to facilitate punching out of the punchout portion 118 depending on the desired cabling configuration employed in the enclosure 100. Similarly, the port 117 may be manufactured as a closed port including a punchout portion 118′ that has a weakened portion 119′ about its periphery to facilitate punching out of the punchout portion 118′ depending on the desired cabling configuration. The drop cables may comprise any drop cable including, for example, a Miniflex® fiber cable or any ungrooved fiber cable. The port 117 is labeled “STUB” in FIGS. 2 and 3.

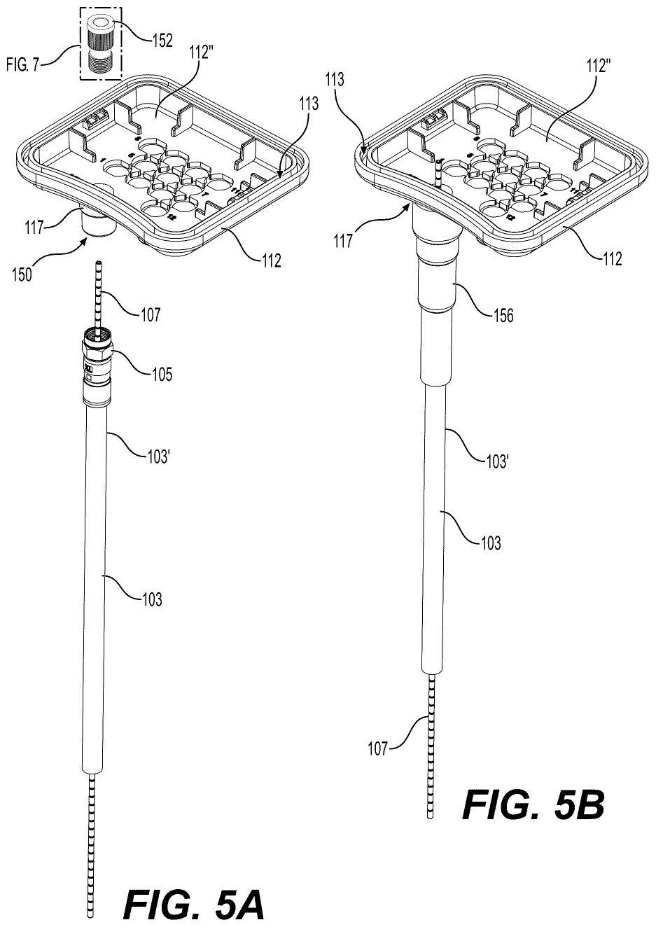

Referring now to FIGS. 5A-7, a coupling assembly 150 is configured to couple the cable 103 to the port 117 of the base 112 of the housing 110. As illustrated, the cable 103 may comprise a single fiber cable, such as, for example, PPC's Aerial All Dielectric Self Supporting (ADSS) fiber cable. The cable 103 may alternatively comprise a multifiber cable or a duct containing a single fiber cable or a multifiber cable, as long as the cable is configured to be terminated with a nut, as described below. In the illustrated embodiment, the cable 103 has a jacket 103′ that is terminated with a nut 105 configured to rotate relative to the jacket 103′ and a fiber cable 107 in the jacket 103′. The fibers 107 of the cable 103 are configured to extend through the nut 105 and the port 117 of the base 112 and into the housing 110 where they can be optically coupled with a splitter, a tap, or another fiber, depending on the desired configuration of the NAP enclosure 100.

In its assembled configuration, the NAP enclosure 100 may include at least one input fiber cable and at least one output fiber cable, but the NAP enclosure 100 will typically include one input fiber cable and a plurality of output fiber cables. The input fiber cable may comprise fiber 103 or one of the fibers 104, and the output fibers comprise two or more of the fibers 104.

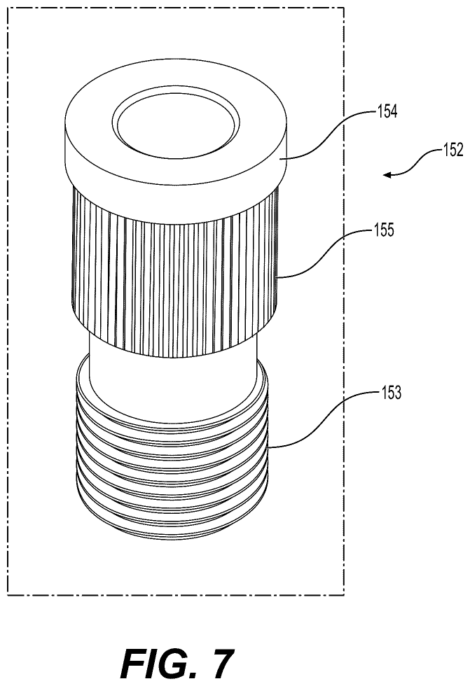

The coupling assembly 150 includes a port adapter 152, as illustrated in FIG. 7, configured to be inserted into the port 117 to provide strain relief between the cable 103 and the base 102. After the punchout portion 118′ is removed, for example, by punching in a direction from a top surface 112″ of the base 112 toward the bottom surface 112′, the port adapter 152 is inserted into a through bore 170 of the port 117 from the top surface 112″. The port adapter 152 includes a threaded portion 153 at a first end and a flange portion 154 at an opposite second end

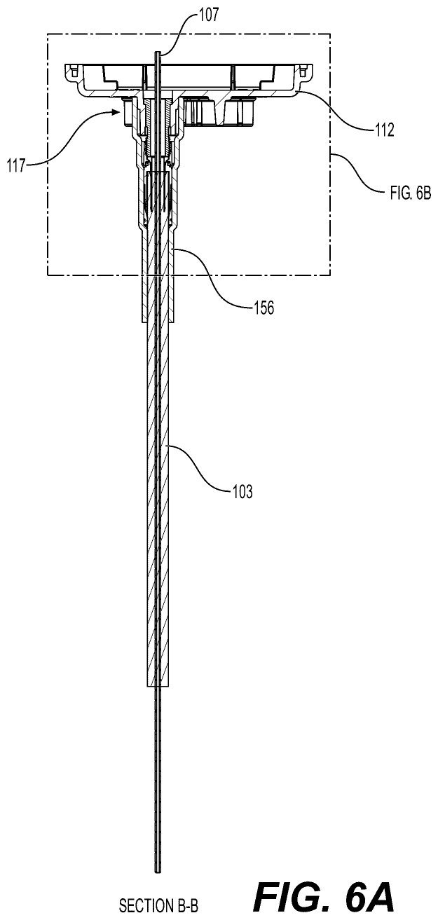

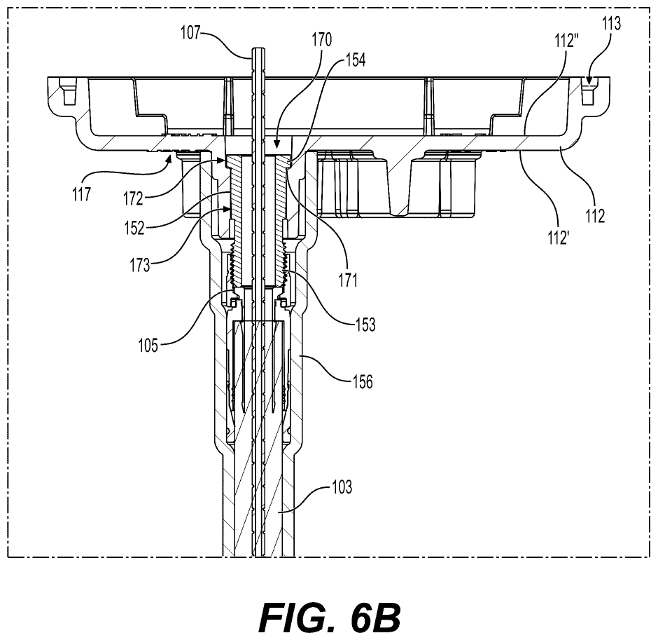

Between the threaded portion 153 and the flange portion 154, the port adapter 152 includes a ribbed portion 155 having longitudinal ribs on an outer surface of the port adapter 153. As best illustrated in FIG. 6B, when inserted into the port 117, the flange portion 154 rests against a shoulder 171 formed in the through bore 170 at a stepped transition from a wider through bore portion 172 to a narrower through bore portion 173. The ribbed portion 155 is received in the narrower through bore portion 173 and may be heat staked or ultrasonically welded to the port 117 to increase torsional strength of the connection.

The threaded portion 153 comprises an F81 interface port configured to threadedly receive the nut 105 of the cable 103. After the nut 105 is threadedly coupled with the threaded portion 153 to a tightened configuration, a heat shrink tubing 156 can be placed over the cable 103, the nut 105, and the port 117 and hermetically sealed at both ends to waterproof the connection between the cable 103 and the port 117.

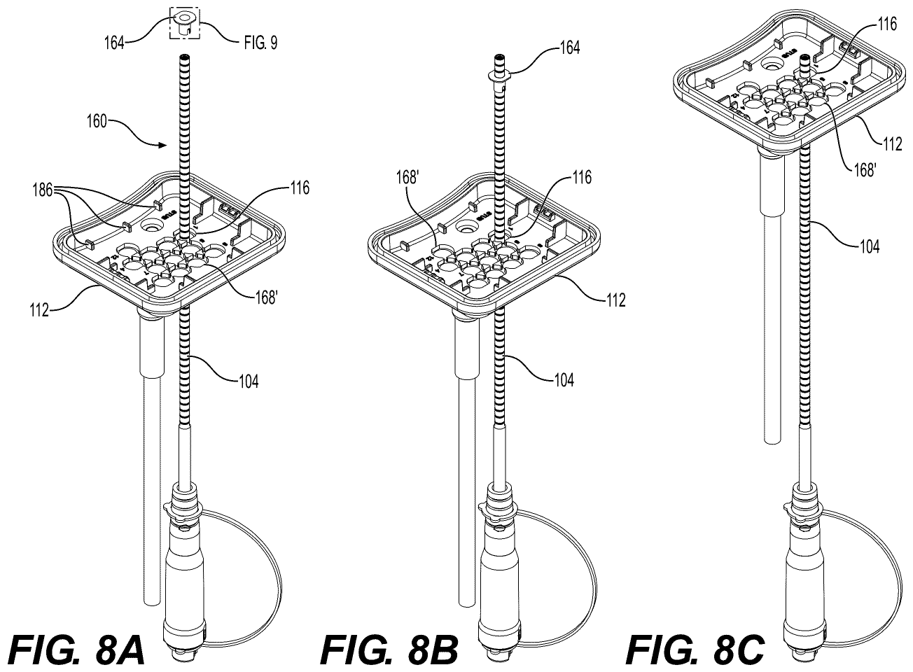

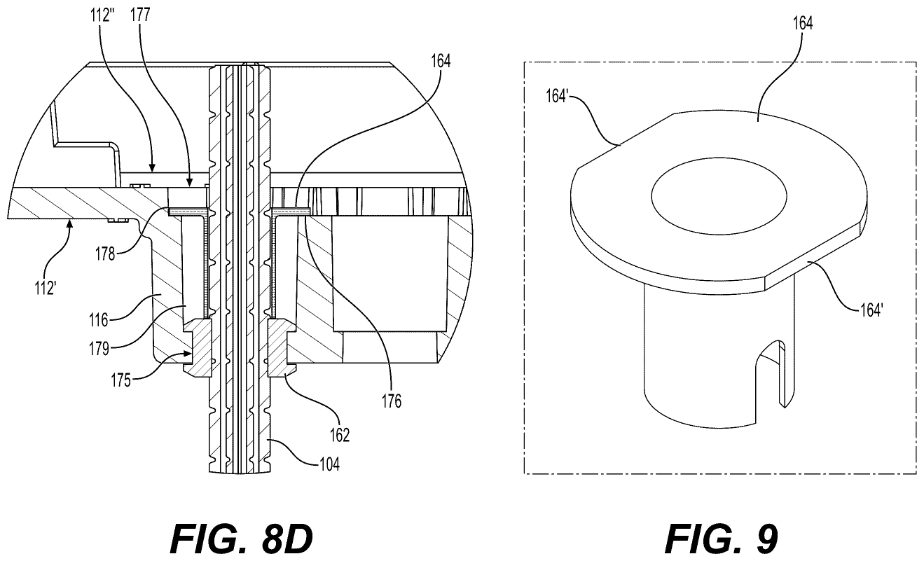

Referring now to FIGS. 8A-9, a coupling assembly 160 is configured to couple a drop cable 104 to one of the ports 116 of the base 112 of the housing 110. As illustrated, the drop cable 104 comprises PPC's Miniflex® fiber cable; however, it should be understood that the drop cable 104 may be any fiber cable. The assembly 160 includes a grommet 162 and a crimp sleeve 164. The grommet is configured to be received in an opening 175 of the port 116. The grommet 162 is configured such that the drop cable 104 can be fed through the grommet 162 from the bottom surface 112′ of the base 112, as shown in FIG. 8A. As shown in FIG. 8B, after the cable 104 is fed through the grommet 162, the crimp sleeve 164 is crimped on a jacket 104′ of the cable 104 at a distance from the end of the jacket 104′. Although not illustrated to avoid confusion, in some exemplary embodiments, a bare fiber (not shown) of the cable 104 may extend 20 inches or more, for example, three feet, beyond the end of the jacket 104′ to provide sufficient slack to store and splice the fiber within the housing 110.

After the crimp sleeve 164 is crimped onto the jacket 104′, the drop cable 104 is pulled back out of housing 110 from the bottom surface 112′ until the crimp sleeve 164 is seated against a shoulder 176 formed in a through bore 177 of the port 116 at a stepped transition from a wider through bore portion 178 to a narrower through bore portion 179, as shown in FIGS. 8C and 8D. The wider through bore portion 178 includes at least one flat region 178′ configured to receive a flat portion 164′ of the crimp sleeve 164 (FIG. 9). In the illustrated embodiment, the wider through bore portion 178 includes two opposing flat regions 178′ configured to receive two opposing flat portions 164′ of the crimp sleeve 164. The crimp sleeve 164 thus provides tension and torsion strain relief between the cable 104 and the base 112.

Referring now to FIGS. 10A-10C, the NAP enclosure 100 includes a retainer 108 configured to be coupled with the base 112 to maintain the position of the fiber cables 103, 104 that extend through the ports 116, 117 into the housing 102. The retainer 108 includes openings 181 configured to be aligned with the ports 116 and an opening 182 configured to be aligned with the port 117. The openings 181 and the opening 182 include tapered and/or curved entrances to prevent the bare fibers from being bent beyond a minimum bend radius when entering the enclosure. The retainer 108 includes latches 183 extending outward from opposite sides 108′ of the retainer 108. The latches 183 are configured to be coupled with catches 185 on the base, as described below. The retainer 108 also includes projections 184 extending outward from the opposite sides 108′ of the retainer and having an enlarged flanged free end 184′. Although the illustrated embodiment includes the latches 183 and projections 184 extending from the same opposite sides 108′, it should be understood that the latches 183 and projections 184 may extend from other and/or different opposite sides of the retainer 108. The retainer 108 may include cable guides 188, 189, as best shown in FIGS. 10A and 10B, to assist with cable routing and management.

The base 112 includes catches 185 extending inward from opposite walls 112′ to an interior of the base 112. The catches 185 are configured to receive the latches 183 to secure the retainer 108 to the base 112, as shown in FIG. 10C. Referring to FIG. 10A, the base 112 may also include structures 186 extending inward from the walls and upward from the top surface 112″ of the base 112 to the interior of the base 112. The structures 186 help to position the retainer 108 relative to the base 102 when coupling the retainer 108 with the base 102. The structures 186 may also support the walls of the retainer 108 when coupled with the base 102.

The retainer 108 eliminates the need for potting the cables in the base 112. The retainer 108 thus saves the mess of potting and the permanency of the potting. For example, once the cables are potted, the cables cannot be rearranged relative to the base. However, with the retainer 108, the cables can be rearranged by unlatching the latches 183 from the catches 185 to free the retainer 108 from the base 112.

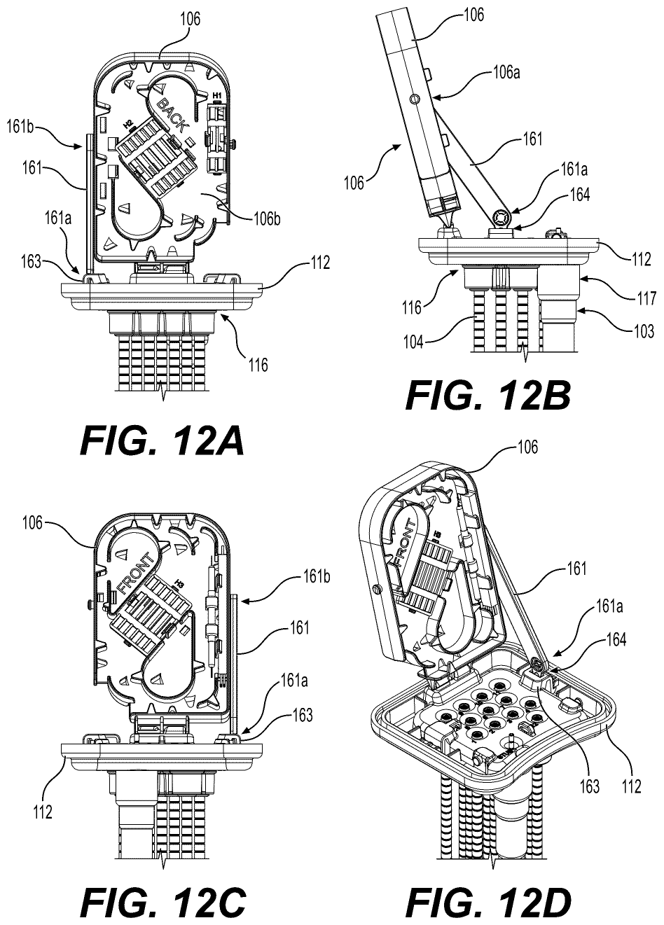

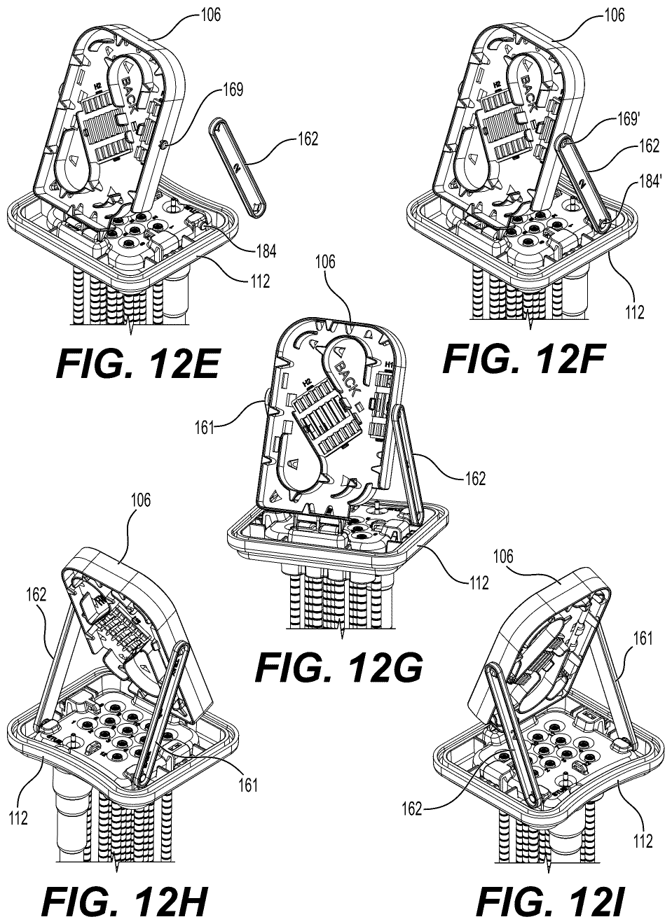

The retainer 108 may also include a hinge receiver 187, and the splice tray 106 (FIG. 11) may include a hinge 130 configured to be pivotally received by the hinge receiver 187. With the retainer 108 latched to the base 112, the hinge 130 and hinge receiver 187 are configured to permit the splice tray 106 to pivot from a position beyond perpendicular relative to the base 112, as shown in FIGS. 12A-12D, to a position at an acute angle relative to the base 112 and within the periphery of the base 112, as shown in FIGS. 12E-12I. The splice tray 106 includes a front side 106a and a back side 106b. The splice tray 106 also includes projections 169 extending outward from opposite side walls 106c, 106d of the splice tray 106 and having an enlarged flanged free end 169′.

Referring to FIG. 11, the splice tray 106 may be manufactured with one or more support arms 161, 162 removably attached thereto. For example, as illustrated, the support arms 161, 162 may be attached to the splice tray 106 by runner segments 163. The runner segments 163 can be clipped off the splice tray 106 and the support arms 161, 162 to separate the support arms 161, 162 from the splice tray 106. The splice tray may include various cable guides to assist with cable routing and management.

The first support arm 161 includes a first end 161a and an opposite second end 161b. The first end 161a includes a first positioning member 164 extending from therefrom. The first positioning member 164 comprises two spaced apart fingers 164′ defining an opening 164″. The opening 164″ narrows at the free end of the fingers 164′, and the fingers 164′ are sufficiently flexible to permit a second positioning member that is larger than the narrowed portion of the opening 164″ to be inserted through the narrowed portion by urging the fingers 164′ apart. The first support arm 161 includes a through hole 167 proximate the first end 161a and a through hole 168 proximate the second end 161b. The through holes 167, 168 are defined by flaps 167′, 168′ are sufficiently flexible such that the flaps 167′, 168′ are configured to be urged radially outward relative to the through hole 167, 168 by the enlarged flanged free end 184′ of one of the projections 184 or by the enlarged flanged free end 169′ of one of the projections 169 as the respective projection is inserted through the through hole 167, 168. The flaps 167′, 168′ are configured to return to their rest configuration after the enlarged flanged free end 184′ or 169′ passes through the through hole 167, 168 to prevent undesired removal of the arm 161 from the projection 184 or 169. The second support arm 162 similarly includes through holes 167, 168 defined by flaps 167′, 168′, but may not include the first positioning member.

Referring again to FIGS. 10A and 10B, each of the latches 163 includes a plateau portion 163′ and a finger portion 163″ configured to be sufficiently flexible to permit the finger portion 163″ to flex inward when being coupled with the catch 185, as would be understood by persons skilled in the art. The plateau portion 163′ of a first one 163a of the latches includes a slot 165 configured to receive the 164′ of the first positioning member 164. The second positioning member 166 is disposed in the slot 165. The second positioning member 166 may comprise a pin that extends perpendicular to an elongated dimension of the slot 165 such the first positioning member 164 is configured to receive the second positioning member 166 in the opening 164″ when the fingers 164′ are inserted into the slot 165.

Referring again to FIGS. 12A-12D, in order to facilitate assembly of the NAP enclosure, the splice tray 106 may be oriented approximately perpendicular to the base 112. To hold the splice tray 106 in the first orientation relative to the base 112 as illustrated in FIGS. 12A-12D, the projection 169 from one side wall 106c of the splice tray 106 is inserted through the through hole 168 proximate the second end 161b of the first support arm 161, and the positioning member 164 of the first support arm 161 is inserted into the slot 165 until the second position member is inserted into the opening 164″ of the first support arm 161. After the second positioning member 166 is inserted through the narrowed portion of the opening 164″, the fingers 164′ return toward their rest position to maintain the second positioning member 166 in the opening 164″ and prevent undesired removal of the first positioning member 164 from the second positioning member 166. Thus, the first positioning member 164 and the second positioning member 166 are configured to hold the splice tray 106 in the first orientation relative to the base 112 as shown in FIGS. 12A-12D. In the first orientation, the front side 106a and the back side 106b are most accessible for assembly. That is, in the first orientation, slack length of the fiber cables 103, 104 can be routed around and/or through various fiber guides on the front side 106a and/or the back side 106b of the splice tray 106; the bare fibers of the fiber cables 103, 104 can be spliced or otherwise optically coupled with a splitter, a tap, or the like; and a splitter, tap, splice sleeve holder, or the like can be attached the front side 106a or the back side 106b of the splice tray 106.

After assembly of the desired optical fiber configuration for the NAP enclosure 100 is complete, the first positioning member 164 can be removed from the second positioning member 166, and the splice tray 106 can be repositioned to a second orientation, as illustrated in FIGS. 12E-12I. In the second orientation, the splice tray 106 is inclined at an acute angle relative to the base 112 such that the cover 114 can be coupled with the base 112 to provide a more compact NAP enclosure 100 than if the splice tray 106 were left in the first orientation. The projection 169 from the one side wall 106c of the splice tray 106 can remain inserted through the through hole 168 proximate the second end 161b of the first support arm 161 as the splice tray 106 is pivoted to the second orientation. In the second orientation, the projection 184 extending outward from a side 108′ of the retainer 108 adjacent to the first support arm 161 is inserted through the through hole 167 proximate the first end 161a.

Although the first support arm 161 may be adequate to maintain the splice tray 106 in the second orientation relative to the base 112, it some aspects, the second support arm 162 may be coupled to the base 112 and the splice tray 106 for additional support. For example, the projection 169 from the one side wall 106d of the splice tray 106 is inserted through one of the through holes 167, 168 of the second support arm 162, and the projection 184 extending outward from a side 108′ of the retainer 108 adjacent to the second support arm 162 is inserted through the other one of the through holes 167, 168 of the second support arm 162.

It should be appreciated that the components of the NAP enclosure 100 may be provided to a customer in an unassembled configuration as a kit such that the customer or another third party could assemble the NAP enclosure 100 in a desired configuration.

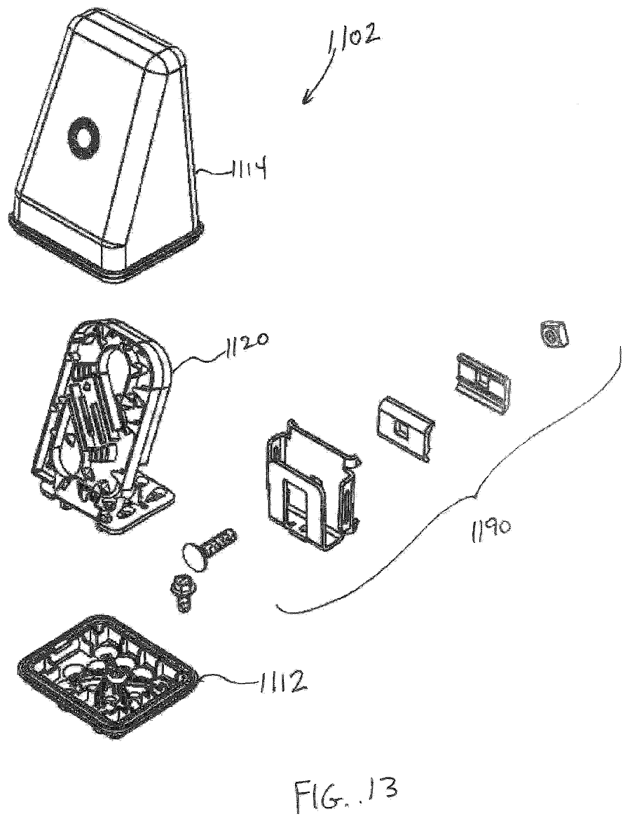

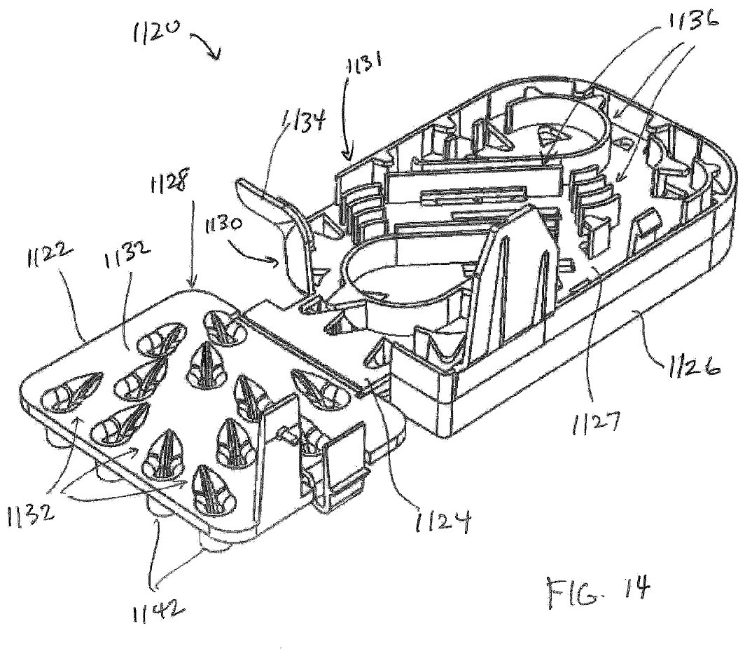

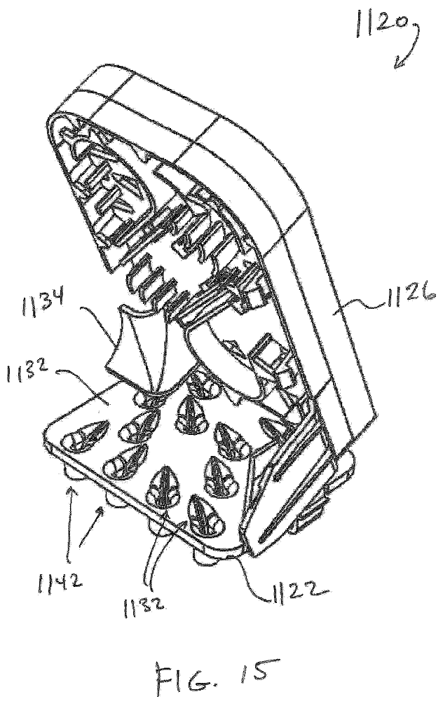

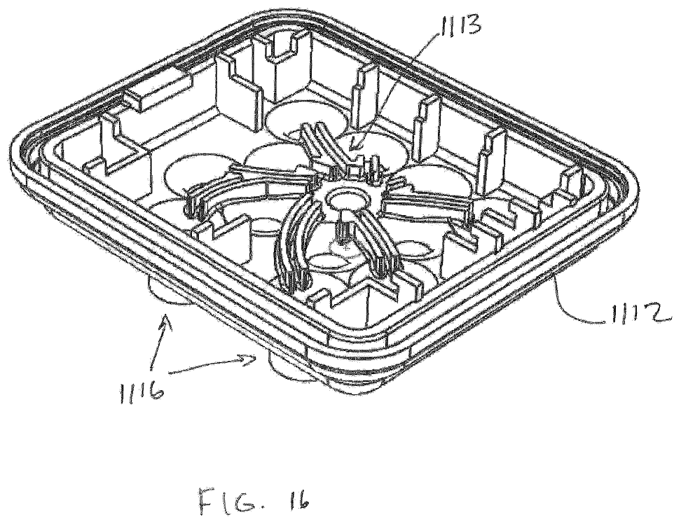

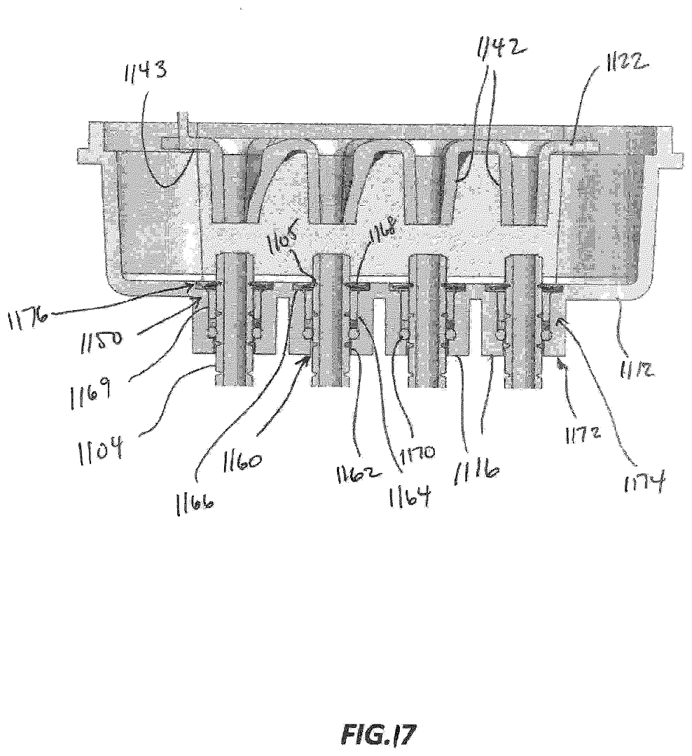

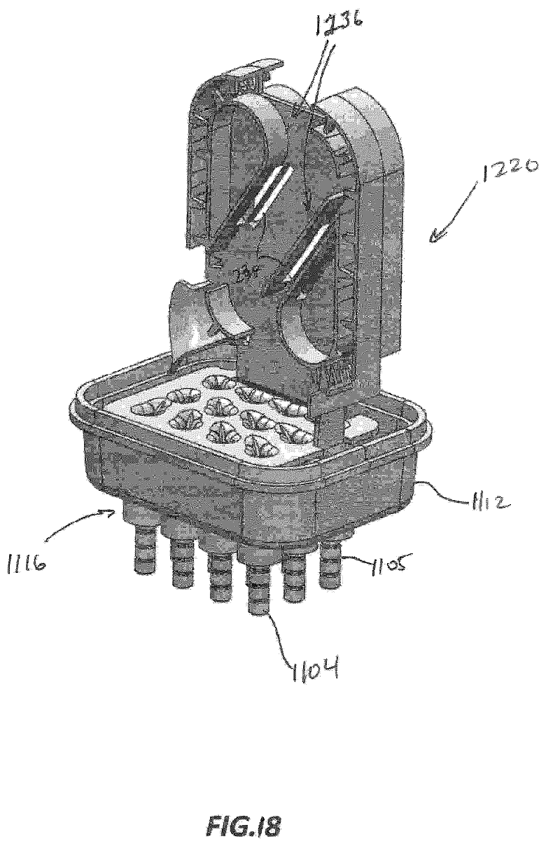

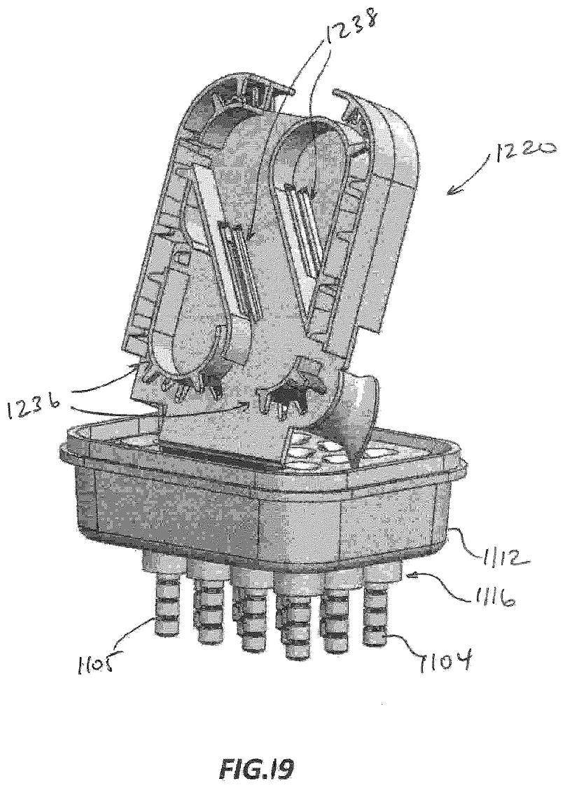

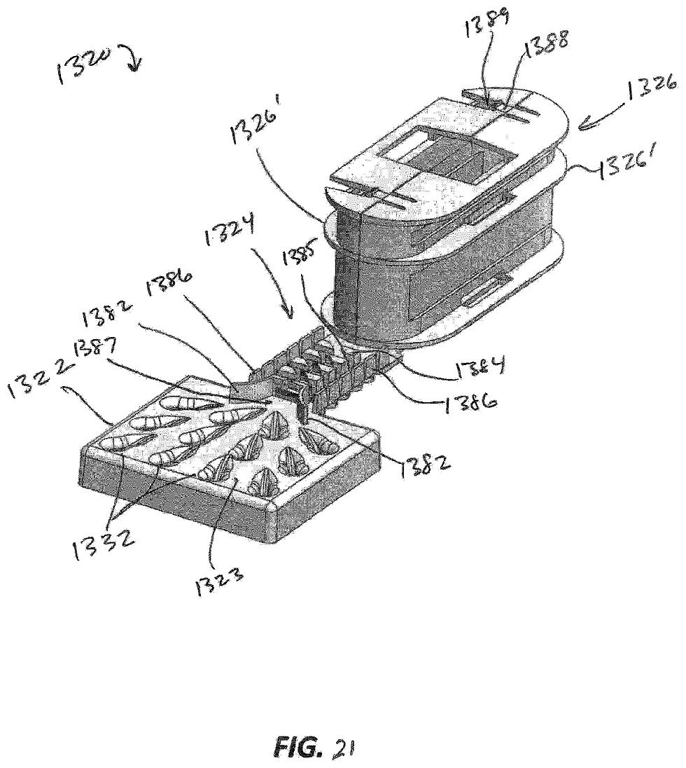

Referring now to FIGS. 13-17, an alternate embodiment of an exemplary NAP enclosure 1100 is illustrated and described. The enclosure 1100 includes a housing 1102 including a base 1112 and a cover 1114. The base 1112 may include a plurality of ports 116, for example, ten output ports configured to receive the output fiber optic cables 1104, one input port configured to receive an multi fiber optic input cable, and one pass through port that can be utilized to connect additional homes or buildings to the fiber optic network system. The base 1112 may include fiber management features 1113 (FIG. 16) configured to facilitate routing of fiber optic cables while ensuring that the fiber optic cables maintain at last a minimum bend radius to prevent signal losses as the optical signal negotiates the arcuate path, curve, or bend of the fiber optic cables.

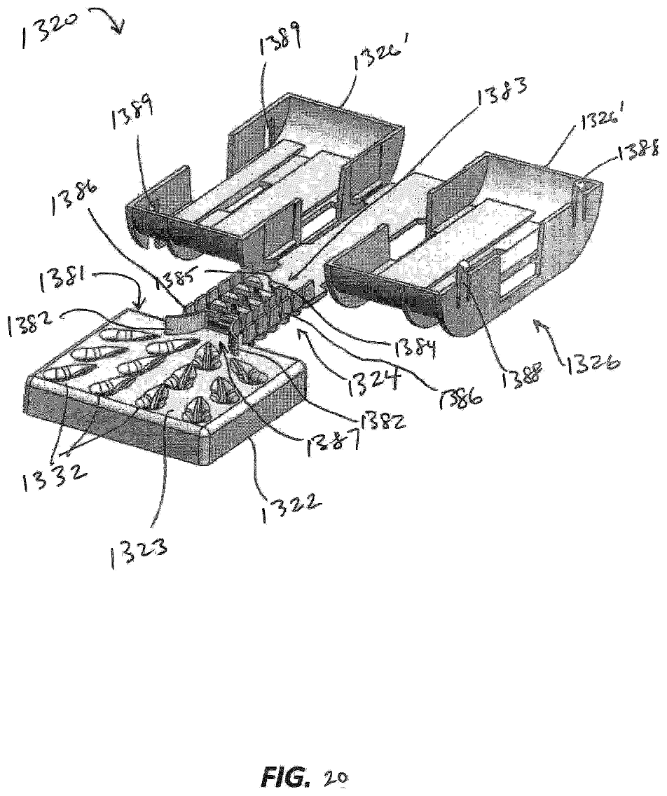

The network access point enclosure 1100 further includes a fiber management and distribution tray 1120 configured to be housed in the housing 1102 and mounting hardware 1190 configured to be attached to a back wall of the housing 1102 and to mount the network access point 1100 to a strand mount or a pole mount (not shown). As shown in FIGS. 14 and 15, the fiber management and distribution tray 1120 may be a monolithic tray of unitary construction. For example, the fiber management and distribution tray 1120 may be molded as a single piece. The fiber management and distribution tray 1120 has an unfolded configuration (FIG. 14) and a folded configuration (FIG. 15).

The fiber management and distribution tray 1120 includes a base portion 1122, a hinge portion 1124 (e.g., a living hinge), and an upper portion 1126. The base portion 1122 includes twelve ports 1142 (FIG. 17) aligned with the twelve ports 1116 of the base 1112. Each of the ports 1142 includes a respective opening 1132 at a top surface 1133 of the base portion 1122. The openings 1132 are contoured at a surface 1123 of the base portion 1122 so as to direct fiber optic cables extending from the ports 1116 and through the openings 1132 toward a first corner 1128 of the base portion 1122.

The upper portion 1126 includes various fiber management features 1136 that extend from a planar surface 1127 of the upper portion 1126. The fiber management features 1136 facilitate routing of fiber optic cables to a splice tray, a breaker, and/or a splitter in the housing 1102 while ensuring that the fiber optic cables maintain at last a minimum bend radius to prevent signal losses as the optical signal negotiates the arcuate path, curve, or bend of the fiber optic cables. The upper portion 1126 also includes a protector 1134 at a first corner 1130 of the upper portion 1126 that is proximate the first corner 1128 of the base portion 1122.

With the fiber management and distribution tray 1120 in the unfolded configuration, the fiber optic cables can be routed to the first corner 1128 of the base portion 1122 and tucked between the protector 1134 and the planar surface 1127 of the upper portion 1126. For example, the protector 1134 may be an L-shaped structure that extend perpendicularly from the planar surface 1127 and turns at an approximately 90° angle in a direction toward an outer side 1131 of the upper portion 1126. Thus, when the fiber management and distribution tray 1120 is folded at the hinge portion 1124 to the folded configuration of FIG. 15, the protector 1134 ensures that the fiber optic cables maintain at last a minimum bend radius.

Referring now to FIG. 17, the ports 1142 extend from a bottom surface 1143 of the base portion 1122 and are aligned with the ports 1116 of the base 1112. The ports 1116 are configured to receive an output fiber optic cable 1104 or an input fiber optic cable. The ports include a coupling assembly 1150 configured to couple the output fiber optic cable 1104 or input fiber optic cable to the base 1112 of the network access point 1100.

The ports 1116 include a through bore 1160 having a first diameter portion 1162 at an exterior end 1172 of the ports 1116, a second diameter portion 1164 at a middle portion 1174 of the ports 1116, and a third diameter portion 1166 at an interior end 1176 of the ports 1116. The third diameter portion 1166 has a greater diameter than the second diameter portion 1164, which has a greater diameter than the first diameter portion 1162. A locking ring 1168, for example, a locking shaft ring, is disposed in the third diameter portion 1166 of the through bore 1160 in a press fit or interference fit such that the locking ring 1168 is retained in the third diameter portion 1166 during normal operation of the network access point 1100. The locking ring 1168 is sized to be received in an annular groove 1105 in an outer surface of the output fiber optic cable 1104 to secure the output fiber optic cable 1104 to the base 1112 of the network access point 1100.

A spacer 1169 is disposed in the second diameter portion 1164 to maintain the output fiber optic cable 1104 in a substantially central position of the through bore 1160. An O-ring or other sealing member 1170 is disposed in the second diameter portion 1164 between the spacer and the first diameter portion 1162 to provide a weathertight seal of the between the output fiber optic cables 1104 and the ports 1116.

Referring to FIGS. 18 and 19, an alternative embodiment of a fiber management and distribution tray 1220 is illustrated and described. The fiber management and distribution tray 1220 includes a more simplified arrangement of fiber management features 1236. While the fiber management features 1236 facilitate routing of fiber optic cables while ensuring that the fiber optic cables maintain at last a minimum bend radius, the fiber management and distribution tray 1220 has more available space for mounting splice trays, splitter, breakouts, or the like 1238.

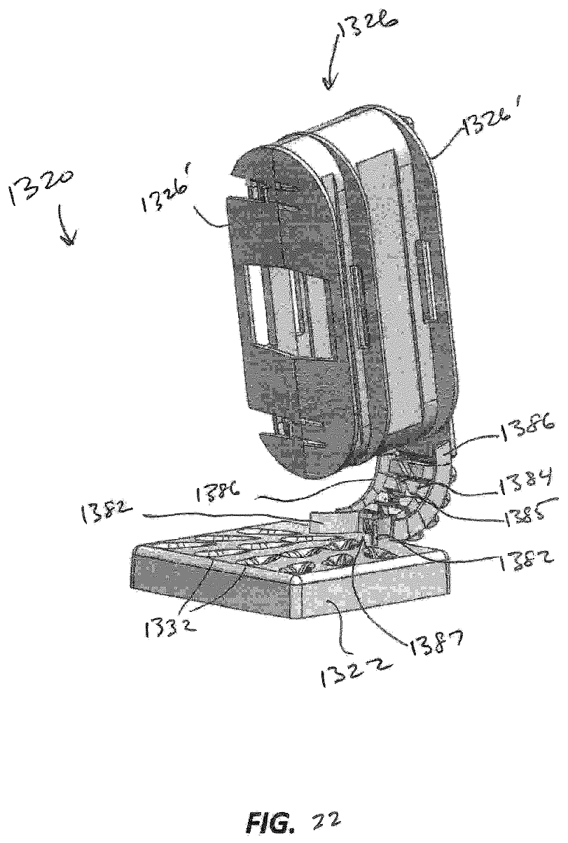

Another alternative embodiment of a fiber management and distribution tray 1320 is illustrated in and described with respect to FIGS. 20-22. The fiber management and distribution tray 1320 may be a monolithic tray of unitary construction. For example, the fiber management and distribution tray 1320 may be molded as a single piece. The fiber management and distribution tray 1320 has an unfolded configuration (FIG. 20), a first folded configuration (FIG. 21), and a second folded configuration (FIG. 22).

The fiber management and distribution tray 1320 includes a base portion 1322, a hinge portion 1324 (e.g., a living hinge), and an upper portion 1326. The base portion 1322 includes twelve ports 1342 aligned with the twelve ports 1116 of the base 1112. Each of the ports 1342 includes a respective opening 1332 at a top surface 1323 of the base portion 1322. The openings 1332 are contoured at the top surface 1323 of the base portion 1322 so as to direct fiber optic cables extending from the ports 1116 and through the openings 1332 toward a center region 1380 of a first end 1381 of the base portion 1322 adjacent the hinge portion 1324. The base portion 1322 also includes a pair of spaced apart guides 1382 that extend from the top surface 1323 of the base portion 1322 proximate the center region 1380 of the first end 1381. The guides 1382 are configured to guide (or funnel) the fiber optic cables extending from the openings 1332 between the guides 1382 and toward the hinge portion 1324. The guides 1382 ensure that the fiber optic cables maintain at last a minimum bend radius as the fiber optic cables pass from the base portion 1322 to the hinge portion 1324.

In the unfolded configuration of the fiber management and distribution tray 1320, the hinge portion 1324 extends in a first direction from the first end 1381 of the base portion 1322 to the upper portion 1326. The hinge portion 1324 includes protection fingers 1383 that extend in a second direction perpendicular to the first direction. The protection fingers 1383 are arranged in two rows that extend in the first direction between the base portion 1322 and the upper portion 1326. The protection fingers 1383 have end portions 1384 that extend in a direction perpendicular to the first and second direction. The end portions 1384 have free ends 1385 that are substantially at a center line between the two rows of protection fingers. As shown, the free ends 1385 of the protection fingers 1383 of one row are tapered in a direction opposite relative to the free ends 1385 of the protection fingers 1383 of the other row such that the free ends 1385 of the one row do not touch the free ends 1385 of the other row. This allows the fiber optic cables to be inserted under the free ends 1385 of the two rows, and the free ends 1385 maintain the fiber optic cables under the end portions 1385 and between the rows.

The hinge portion 1324 also includes bend limiters 1386 that extend in the second direction and are arranged in two rows that extend in the first direction. The protection fingers 1383 are between the bend limiters 1386. The bend limiters 1386 are configured to limit the extent to which the hinge portion 1324 can bend, thereby ensuring that the fiber optic cables maintain at last a minimum bend radius as the fiber optic cables pass through the hinge portion 1324.

As shown in FIG. 20, in the unfolded configuration of the fiber management and distribution tray 1320, the upper portion 1326 includes two half portions 1326′ that extend in opposite directions from a center region 1387 that extends in the first direction from the hinge portion 1324. When folded to the first folded configuration (FIG. 21), the two half portions 1326′ meet one another to form an upper portion 1326 having a substantially oval shape in the first direction. One of the half portions 1326′ includes latching fingers 1388, and the other one of the half portions 1326′ includes recesses 1389 configured to receive the latching fingers 1388 to maintain the upper portion 1326 in the first folded configuration. In use, the fiber optic cables can be routed through the openings 1332, through the hinge portion 1324, and to a splice tray, splitter, or breakout on the upper portion 1326. The upper portion 1326 may include structures, such as recesses or the like, for holding splice trays, splitters, or breakouts, as would be understood by persons skilled in the art.

Once the fiber optic cables are routed, the upper portion 1326 can be rotated upward by bending at the hinge portion 1324. The bend limiters 1386 are configured to limit the extent to which the hinge portion 1324 can bend, thereby ensuring that the fiber optic cables maintain at last a minimum bend radius as the fiber optic cables pass through the hinge portion 1324.

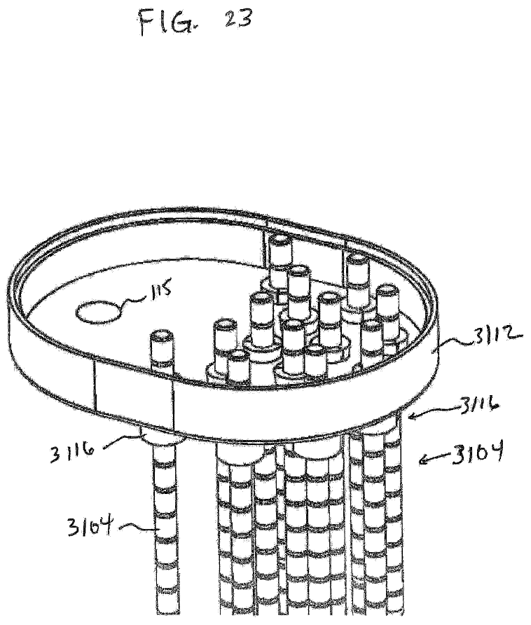

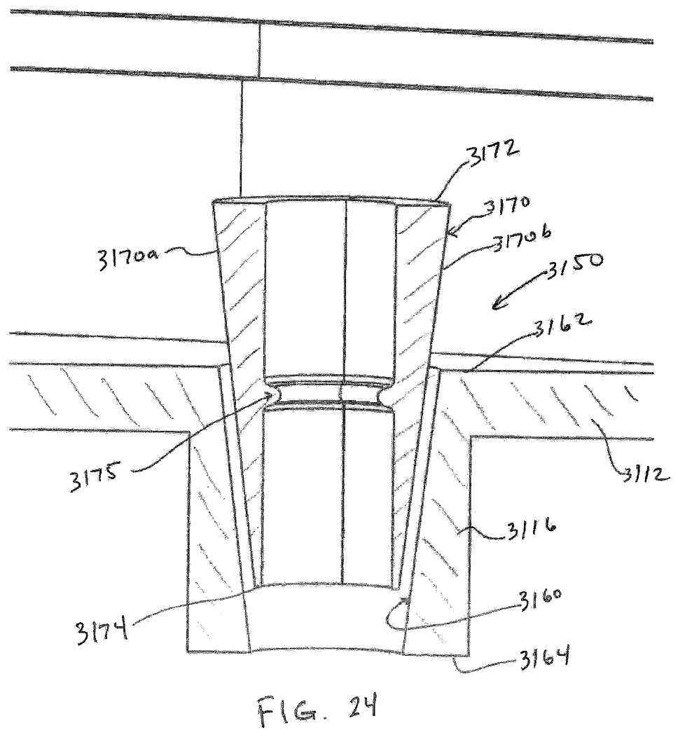

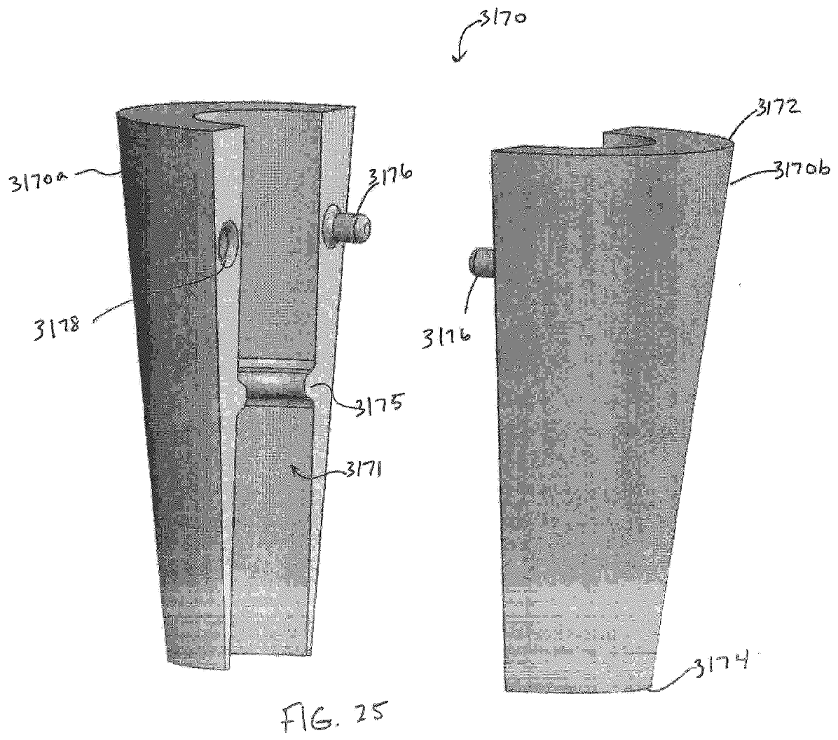

Referring now to FIG. 23-35, various means for connecting fiber optic cables to ports of a NAP enclosure 3100 are illustrated and described. As illustrated in FIG. 23, the base 3112 may include one input port 3115 configured to receive a multi fiber optic input cable and twelve output ports 3116 configured to receive the output fiber optic cables 3104. The base 3112 may include fiber management features (not shown) configured to facilitate routing of fiber optic cables while ensuring that the fiber optic cables maintain at last a minimum bend radius to prevent signal losses as the optical signal negotiates the arcuate path, curve, or bend of the fiber optic cables.

One or more of the ports 3116 include a coupling assembly 150 configured to couple the output fiber optic cable 3104 to the base 3112 of the network access point 3100. The coupling assembly 3150 includes a through bore 3160 of the port 3116 and a plug 3170. The through bore 3160 tapers from a first diameter at an interior end 3162 of the port 3116 to a second diameter at an exterior end 3164 of the port 3116. The plug 3170 has an outer diameter that tapers from a first end 3172 to a second end 3174. The taper of the plug 3170 may match the taper of the through bore 3160. The plug 3170 may be a plastic, an elastomer, rubber, or the like.

As shown in FIG. 25, the plug 3170 may be formed of two identical halves 3170a, 3170b that are configured to be coupled to one another, for example, by a protrusion 3176 that extends from one wall surface of each half 3170a, 3170b and a recess 3178 in an opposite wall surface of each half 3170a, 3170b that is configured to receive the protrusion 3176. The plug 3170 may include an annular ridge 3175 (or a plurality of circumferentially extending ridges) extending radially inward from an inner surface 3171 of the plug 3170. The annular ridge 3175 may be configured to be received by an annular groove in an outer wall of an output fiber optic cable 3104, such as for example, a Miniflex® fiber cable or duct, to prevent relative movement between the cable and the plug 3170. It should be appreciated that the plug 3170 may also be used with an ungrooved cable or duct, and the annular ridge 3175 would provide increased gripping force on the cable or duct.

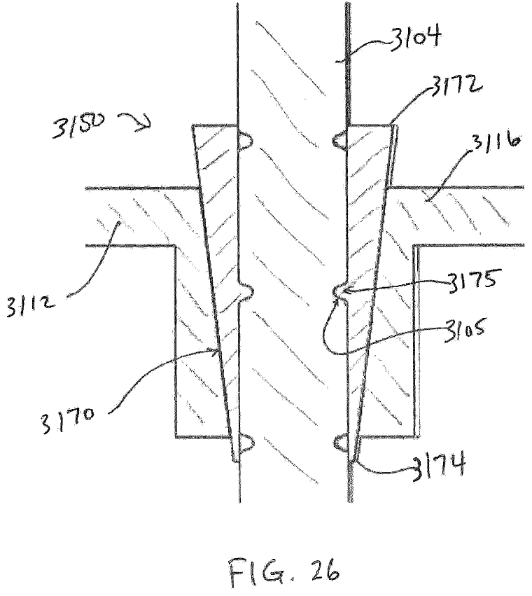

In FIG. 26, the coupling assembly 3150 is shown with the plug 3170 disposed about the output fiber optic cable 3104 such that the annular ridge 3175 is received by a groove 3105 in the output fiber cable 3104. The plug 3170 is also shown inserted into the through bore 3160 such that the plug 3170 is urged by the port 3116 against the cable 3104 by the opposed tapered surfaces to seal the interface between the port 3116 and the cable 3104.

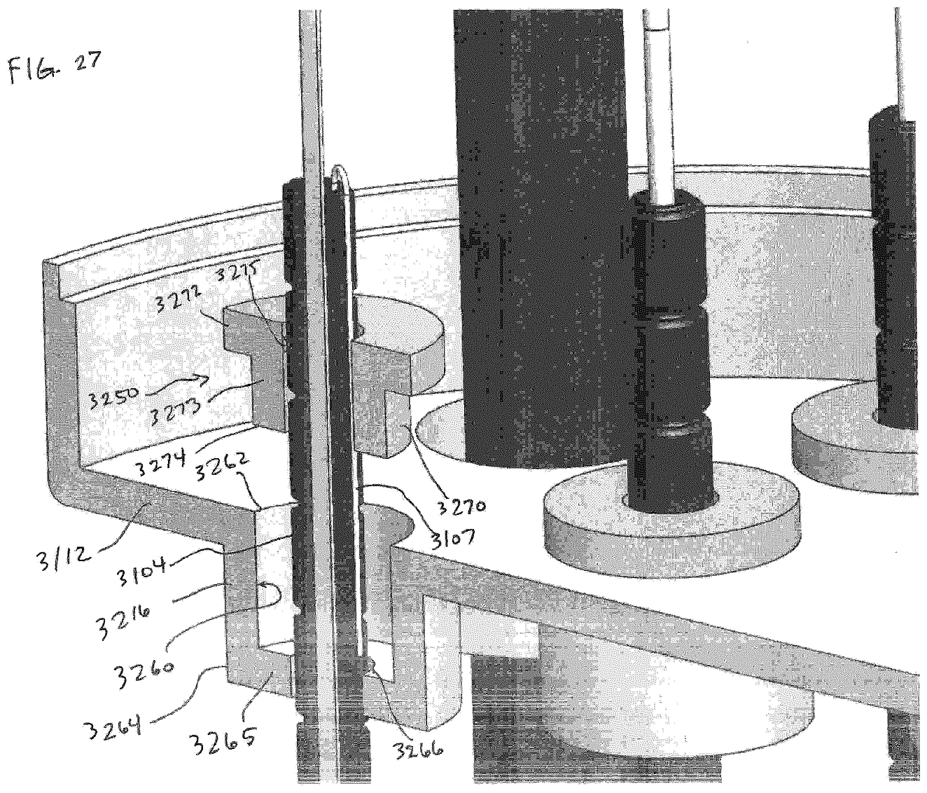

Referring now to FIG. 27, an alternative coupling assembly 3250 is illustrated. The coupling assembly 3250 is configured to couple the output fiber optic cable 3104 to the base 3112 of the network access point 100. The coupling assembly 3250 includes a bore 3260 of the port 3216 and a plug 3270. The bore 3260 has a first diameter extending from an interior end 3262 of the port 3216 to an end wall 3265 at an exterior end 3264 of the port 3216. The end wall 3265 includes a through hole 3266 having a second diameter smaller than the first diameter. The through hole 3266 is configured to receive the output fiber cable 104 therethrough. The plug 3270 may be a plastic, an elastomer, rubber, or the like.

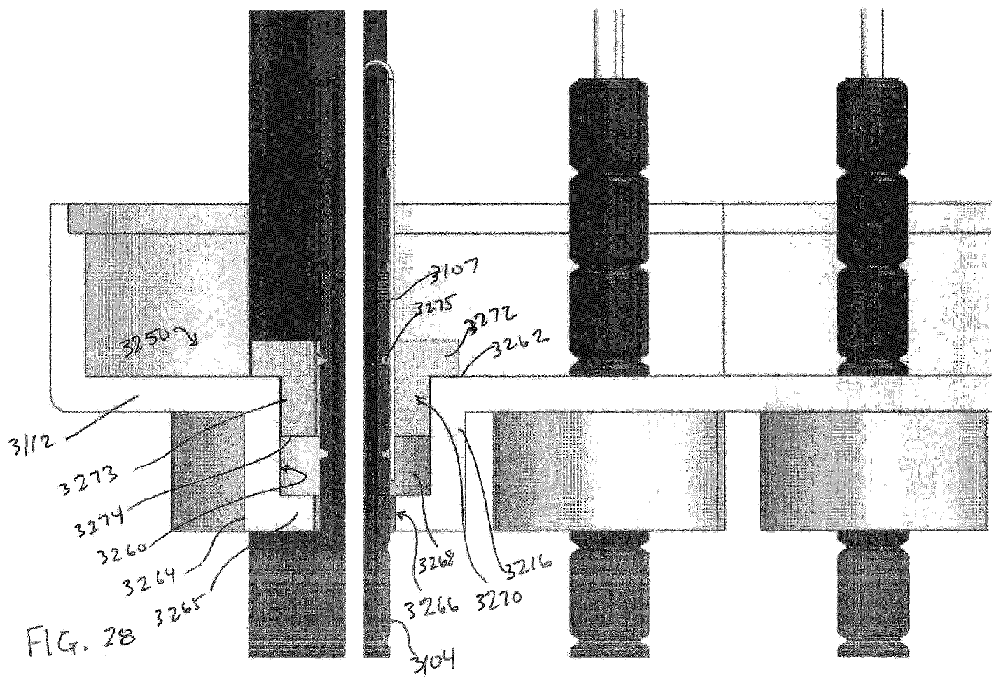

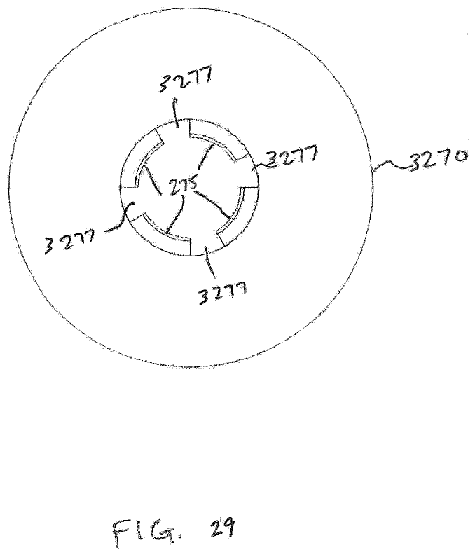

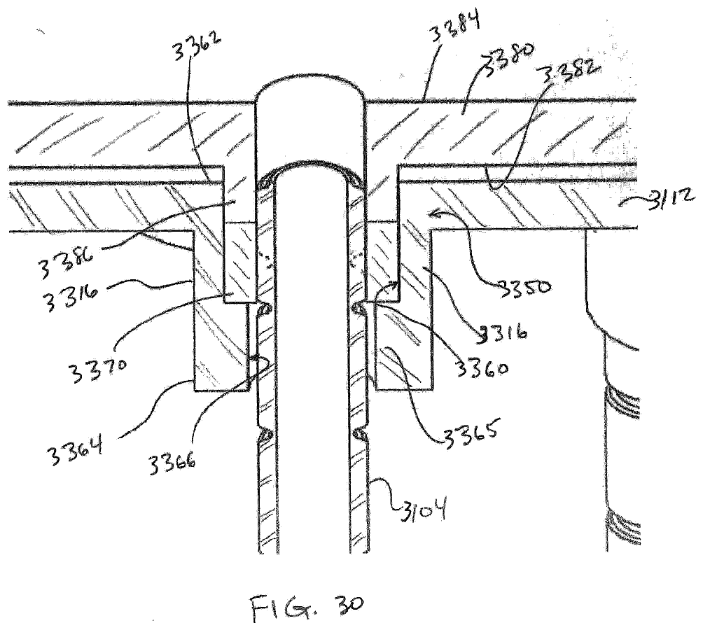

The plug 3270 has a flanged first end 3272 and a cylindrical portion 3273 that extends from the flanged first end 3272 to a second end 3274. The flanged first end 3272 has an outer diameter that is greater than the first diameter of the bore 3260, and the cylindrical portion 3273 has an outer diameter that is greater than the second diameter of the through hole 3266. In some aspects, the outer diameter of the cylindrical portion 3273 may be smaller than the first diameter of the bore 3260. In other aspects, the outer diameter of the cylindrical portion 3273 may be slightly greater than the first diameter of the bore 3260 such that the plug 3270 is compressed radially inward when inserted into the bore 3260 to provide a seal between the bore 3260 and the cylindrical portion 3273 of the plug 3270. In either case, the cylindrical portion 3273 can be inserted into the bore 3260 until the flanged first end 3272 is adjacent the interior end 3262 of the port 3216, as shown in FIG. 28.

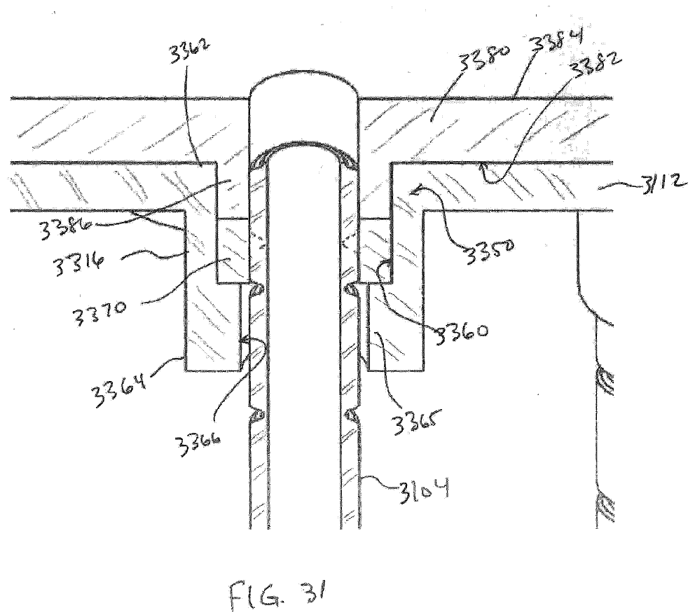

As best illustrated in FIG. 29, the plug 3270 may include a plurality of circumferentially extending ridges 3275 extending radially inward from an inner surface 3271 of the plug 3270. The spaces 3277 between the ridges 3275 may permit a strengthening member 3107 of the cable 3104 to be pulled back over the cable 3104 and passed through the one of the spaces 3277, as shown in FIGS. 27 and 28.

The circumferentially extending ridges 3275 may be configured to be received by an annular groove in an outer wall of an output fiber optic cable 3104, such as for example, a Miniflex® fiber cable or duct, to prevent relative movement between the cable and the plug 3270. It should be appreciated that the plug 3270 may also be used with an ungrooved cable or duct, and the circumferentially extending ridges 3275 would provide increased gripping force on the cable or duct. As shown, the coupling assembly 3250 is shown with the plug 3270 disposed about the output fiber optic cable 3104 such that the circumferentially extending ridges 3275 are received by the groove 3105 in the output fiber cable 3104. It should be appreciated that the space 3268 in the bore 3260 below the second end 3274 of the plug 3270 may be filled with epoxy to hold the output fiber cable 3104 and/or seal the interfaces between the port 3216, the plug 3270, and the output fiber cable 104.

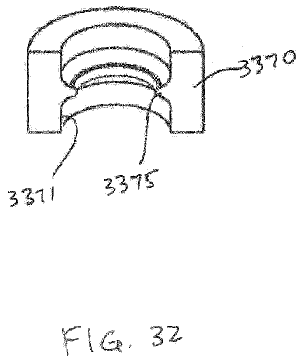

Referring now to FIGS. 30 and 31, another alternative coupling assembly 3350 is illustrated. The coupling assembly 3350 is configured to couple the output fiber optic cable 3104 to the base 3112 of the network access point 3100. The coupling assembly 3350 includes a bore 3360 of the port 3316, a grommet 3370, and a plate 3380. The bore 3360 has a first diameter extending from an interior end 3362 of the port 3316 to an end wall 3365 at an exterior end 3364 of the port 3316. The end wall 3365 includes a through hole 3366 having a second diameter smaller than the first diameter. The through hole 3366 is configured to receive the output fiber cable 3104 therethrough. The grommet 3370 may be a plastic, an elastomer, rubber, or the like.

The grommet 3370 is generally cylindrical and has an outer diameter that is greater than the second diameter of the through hole 3366. In some aspects, the outer diameter of the grommet 3370 may be smaller than the first diameter of the bore 3360. In other aspects, the outer diameter of the grommet 3370 may be slightly greater than the first diameter of the bore 3360 such that the grommet 3370 is compressed radially inward when inserted into the bore 3360 to provide a seal between the bore 3360 and the grommet 3370. In either case, the grommet 3370 can be inserted into the bore 3360 until the grommet 3370 is adjacent the end wall 3365 of the port 3316, as shown in FIGS. 30 and 31.

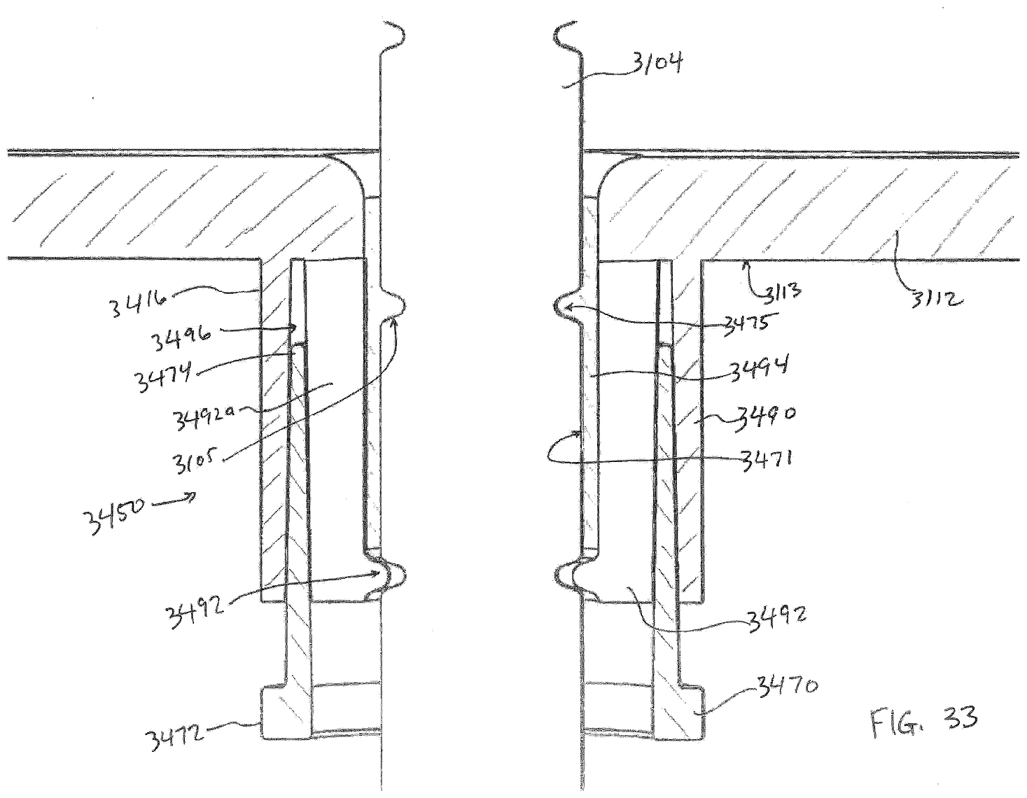

As best illustrated in FIG. 32, the grommet 3370 may include an annular ridge 3375 (or a plurality of circumferentially extending ridges) extending radially inward from an inner surface 3371 of the grommet 3370. The annular ridge 3375 may be configured to be received by an annular groove in an outer wall of an output fiber optic cable 3104, such as for example, a Miniflex® fiber cable or duct, to prevent relative movement between the cable and the grommet 3370. It should be appreciated that the grommet 3370 may also be used with an ungrooved cable or duct, and the annular ridge 3375 would provide increased gripping force on the cable or duct. As shown in FIGS. 30 and 31, the coupling assembly 3350 is shown with the grommet 3370 disposed about the output fiber optic cable 3104 such that the annular ridge 3375 (shown in broken lines) are in contact with an ungrooved portion of the output fiber cable 3104.

The plate 3380 includes a first surface 3382 facing an interior of the housing 3102 and an opposite second surface 3384 facing the base 3112 of the network access point 3100. The plate 3380 includes a cylindrical projection 3386 extending from the second surface 3384. The cylindrical projection 3386 is sized and configured to be inserted into the bore 3360 until the second surface 3384 is near to or engaged with the interior end 3362 of the port 3316, as shown in FIG. 31. In some aspects, the outer diameter of cylindrical projection 3386 may be smaller than the first diameter of the bore 3360. In other aspects, the outer diameter of the cylindrical projection 3386 may be slightly greater than the first diameter of the bore 3360 such that the cylindrical projection 3386 is compressed radially inward when inserted into the bore 3360 to provide a seal between the bore 3360 and the cylindrical projection 3386.

As shown in FIG. 30, a combined axial length of the grommet 3370 and the cylindrical projection 3386 is greater than a length of the bore 3360. When the plate 3380 is urged toward the base 3112, the grommet 3370 is axially compressed, which causes the grommet to expand radially inward and outward into contact with the port 3316 and the cable 3104. The plate 3380 is configured to maintain the position shown in FIG. 31 where the grommet 3370 is compressed and seals the interface between the port 3316 and the cable 3104.

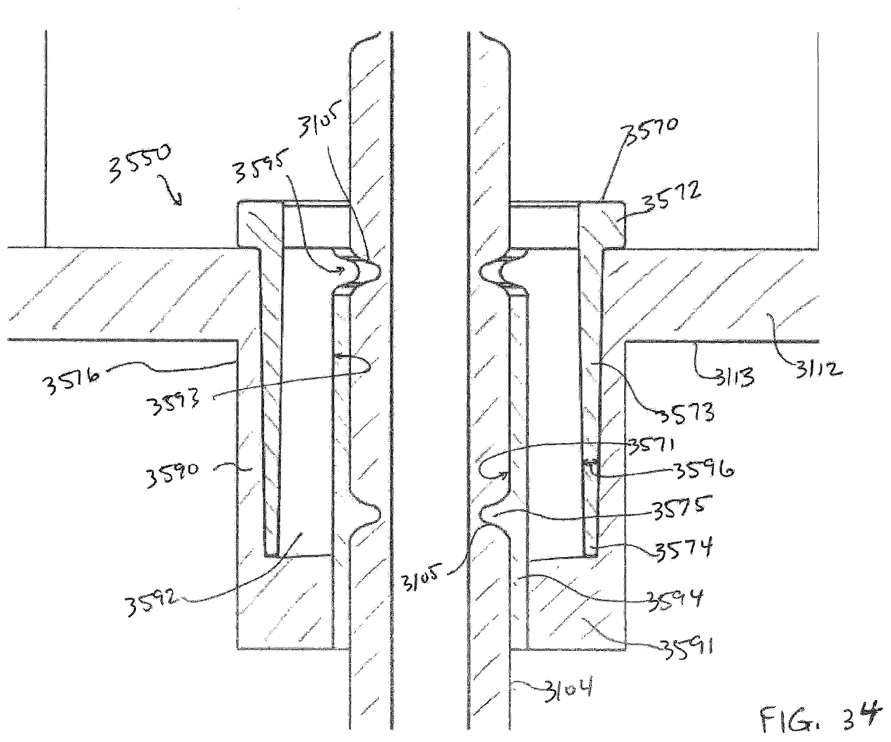

Referring now to FIG. 33, another alternative coupling assembly 3450 is illustrated. The coupling assembly 3450 is configured to couple the output fiber optic cable 3104 to the base 3112 of the network access point 3100. The coupling assembly 3450 includes an outer wall 3490, and inner wall 3492, a sleeve 3494, and a cap 3470. The outer wall 3490 is configured as a cylindrical wall that extends from a surface 3113 of the base 3112 exterior of the network access point 3100. The inner wall 3492 extends from the surface 3113 of the base 3112 exterior of the network access point 3100 and is radially inward from the outer wall 3490, separated by a cylindrical space 3496. As illustrated, the inner wall 3492 includes two semicylindrical wall portions (only one wall portion 3492a is shown) that are separated from one another along their length so as to permit the two wall portions to be urged radially inward.

The inner wall 3492 may include an annular ridge 3495 (or a plurality of circumferentially extending ridges) extending radially inward from an inner surface 3493 of the inner wall 3492. The annular ridge 3495 may be configured to be received by an annular groove in an outer wall of an output fiber optic cable 3104, such as for example, a Miniflex® fiber cable or duct, to prevent relative movement between the cable and the inner wall 3492. It should be appreciated that the inner wall 3492 may also be used with an ungrooved cable or duct, and the annular ridge 3495 would provide increased gripping force on the cable or duct.

The cap 3470 has a flanged first end 3472 and a cylindrical portion 3473 that extends from the flanged first end 3472 to a second end 3474. The cylindrical portion 3473 is sized and arranged to be inserted into the space 3496 between the outer wall 3490 and the inner wall 3492 from an exterior of the network access point 3100. The cylindrical portion 3473 has a radial thickness that tapers from the flanged first end 3472 to the second end 3474, with the radial thickness near the flanged first end 3472 being greater than the radial distance of the space 3496 between the outer wall 3490 and the inner wall 3492. As such, when the cylindrical portion 3473 is inserted into the space 3496, the cylindrical portion 3472 is configured to urge the inner wall 3492 radially inward toward the output fiber cable 3104. The flanged first end 3472 has an outer diameter that is greater than an inside diameter of the outer wall 3490 to limit the distance that the cylindrical portion 3473 can be inserted into the space 3496 between the outer wall 3490 and the inner wall 3492.

The sleeve 3494 includes an annular ridge 3475 (or a plurality of circumferentially extending ridges) extending radially inward from an inner surface 3471 of the sleeve 3494. The annular ridge 3475 may be configured to be received by an annular groove 3105 in an outer wall of an output fiber optic cable 3104, such as for example, a Miniflex® fiber cable or duct, to prevent relative movement between the cable and the plug 3170. It should be appreciated that the sleeve 3494 may also be used with an ungrooved cable or duct, and the annular ridge 3475 would provide increased gripping force on the cable or duct. The sleeve 3494 may be a plastic, an elastomer, rubber, or the like.

As shown in FIG. 33, the sleeve 3494 is disposed about the output fiber optic cable 3104 such that the annular ridge 3495 is received by the groove 3105 in the output fiber cable 3104. When the cylindrical portion 3473 is inserted into the space 3496 and urges the inner wall 3492 radially inward toward the output fiber cable 3104, the inner wall 3492 urges the sleeve 3494 against the cable 3104 to seal the interface between the port 3416 and the cable 3104.

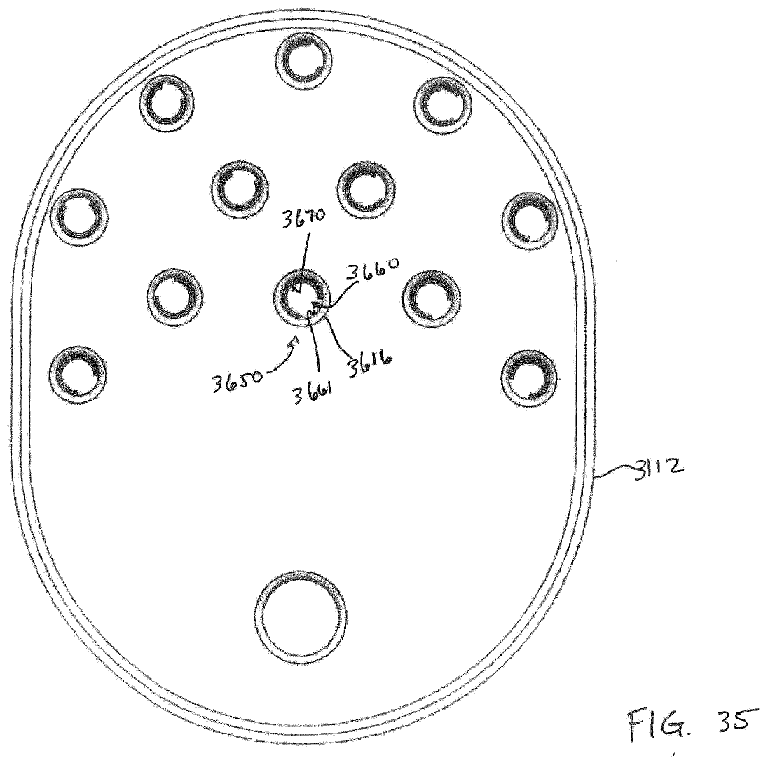

Referring now to FIG. 34, another alternative coupling assembly 3550 is illustrated. The coupling assembly 3550 is configured to couple the output fiber optic cable 3104 to the base 3112 of the network access point 3100. The coupling assembly 3550 includes an outer wall 3590, and inner wall 3592, a sleeve 3594, and a cap 3570. The outer wall 3590 is configured as a cylindrical wall that extends from a surface 3113 of the base 3112 exterior of the network access point 3100. The inner wall 3592 extends from an end 3591 of the outer wall 3590 toward the surface 3113 of the base 3112 exterior of the network access point 3100 and is radially inward from the outer wall 3590, separated by a cylindrical space 3596. As illustrated, the inner wall 3592 includes two semicylindrical wall portions (only one wall portion 3592a is shown) that are separated from one another along their length so as to permit the two wall portions to be urged radially inward.

The inner wall 3592 may include an annular ridge 3595 (or a plurality of circumferentially extending ridges) extending radially inward from an inner surface 3593 of the inner wall 3592. The annular ridge 3595 may be configured to be received by an annular groove in an outer wall 3105 of an output fiber optic cable 3104, such as for example, a Miniflex® fiber cable or duct, to prevent relative movement between the cable and the inner wall 3592. It should be appreciated that the inner wall 3592 may also be used with an ungrooved cable or duct, and the annular ridge 3595 would provide increased gripping force on the cable or duct.

The cap 3570 has a flanged first end 3572 and a cylindrical portion 3573 that extends from the flanged first end 3572 to a second end 3574. The cylindrical portion 3573 is sized and arranged to be inserted into the space 3596 between the outer wall 3590 and the inner wall 3592 from an interior of the network access point 3100. The cylindrical portion 3573 has a radial thickness that tapers from the flanged first end 3572 to the second end 3574, with the radial thickness near the flanged first end 3572 being greater than the radial distance of the space 3596 between the outer wall 3590 and the inner wall 3592. As such, when the cylindrical portion 3573 is inserted into the space 3596, the cylindrical portion 3573 is configured to urge the inner wall 3592 radially inward toward the output fiber cable 3104. The flanged first end 3572 has an outer diameter that is greater than an inside diameter of the outer wall 3590 to limit the distance that the cylindrical portion 3573 can be inserted into the space 3596 between the outer wall 3590 and the inner wall 3592.

As shown in FIG. 34, the sleeve 3594 is disposed about the output fiber optic cable 3104 such that an annular ridge 3575 (or a plurality of circumferentially extending ridges) extending radially inward from an inner surface 3571 of the sleeve 3594 is received by the groove 3105 in the output fiber cable 3104. The sleeve 3594 may be a plastic, an elastomer, rubber, or the like. When the cylindrical portion 3573 is inserted into the space 3596 and urges the inner wall 3592 radially inward toward the output fiber cable 3104, the inner wall 3592 urges the sleeve 3594 against the cable 3104 to seal the interface between the port 3516 and the cable 3104.

Referring now to FIG. 35, another alternative coupling assembly 3650 is illustrated. The coupling assembly 3650 is configured to couple the output fiber optic cable 3104 to the base 3112 of the network access point 3100. The coupling assembly 3650 includes a through bore 3660 of the port 3616 and a rib 3670 extending radially inward from a wall 3661 of the through bore 3660. As shown, the rib 3670 may extend about a portion of the inner circumference of the through bore 3660. The rib 3670 is configured to be received by an annular groove in an outer wall of an output fiber optic cable 3104, such as for example, a Miniflex® fiber cable or duct, to prevent relative movement between the cable 3104 and the port 3616. The rib 3670 may be configured to urge the cable 3104 against the wall 3661 of the through bore such that the rib 3670, the wall 3661, and the cable cooperate to seal the interface between the port 3616 and the cable 3104.

It should be appreciated that epoxy may be used in combination with any of the aforementioned coupling assemblies to hold the output fiber cable 3104 and/or seal the interfaces between the port and the output fiber cable 3104.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A network access point enclosure configured to sealingly house a splice tray that is configured to pivot to provide increased access to opposite sides of the splice tray during assembly, comprising:
a base portion structurally configured to include a plurality of ports configured to receive fiber optic cables;
a splice tray configured to be pivotally coupled with the base portion;
a support portion having a first end portion structurally configured to be pivotally coupled to the splice tray;
wherein the support portion has a second end portion that is structurally configured to be movable from a first engagement portion to a second engagement portion to permit the splice tray to be pivoted from a first orientation relative to the base portion to a second orientation relative to the base portion;
wherein the splice tray is configured to form a larger angle relative to the base portion in the first orientation than in the second orientation; and
wherein the second end of the support portion is structurally configured to engage the first engagement portion such that the splice tray is maintained in the first orientation so as to provide increased access to a front side of the splice tray and a rear side of the splice tray in the first orientation than in the second orientation.

2. The network access point enclosure of claim 1, further comprising a cover portion configured to be coupled with the base portion.

3. The network access point enclosure of claim 2, wherein the splice tray is configured to prevent the cover portion from being coupled with the base in the first orientation; and
wherein the splice tray is configured to permit the cover portion to be sealingly coupled with the base in the second orientation.

4. The network access point enclosure of claim 1, further comprising a retainer configured to be coupled with the base.

5. The network access point enclosure of claim 4, wherein the retainer includes a first engagement structure configured to receive a first portion of a support arm that extends from the splice tray to hold the splice tray in the first orientation; and
wherein the retainer includes a second engagement structure configured to receive a second portion of a support arm to hold the splice tray in the second orientation.

6. The network access point enclosure of claim 5, wherein the retainer includes a third engagement structure configured to receive a portion of a second support arm that extends from the splice tray to hold the splice tray in the second orientation.

7. The network access point enclosure of claim 1, wherein the retainer is configured to be removed from the base.

8. The network access point enclosure of claim 1, wherein the base portion includes a plurality of ports configured to receive fiber optic cables.

9. The network access point enclosure of claim 8, wherein each port is configured to couple with a fiber optic cable such that the fiber optic cable is rotatingly and slidingly fixed relative to the one port.

10. The network access point enclosure of claim 8, further comprising a coupling assembly configured to couple a fiber optic cable with one of the ports of the base; and
wherein the coupling assembly includes an adapter having a threaded interface port configured to receive a threaded coupler that is attached to and configured to rotate relative to the fiber optic cable.

11. The network access point enclosure of claim 10, wherein the fiber optic cable is configured to be sealingly coupled with the port with heat shrink.

12. The network access point enclosure of claim 8, wherein at least one of the plurality of ports is configured to sealingly receive a drop cable.
